(19) United States
(12) Patent Application Publication
(10) Pub. No.: US 2024/0412057 A1
(43) Pub. Date: Dec. 12, 2024

(54) Method and Apparatus for Optical Information Processing

(71) Applicants: HUAWEI TECHNOLOGIES CANADA CO., LTD., Kanata (CA); Institut National de la Recherche Scientifique, Quebec City (CA)

(72) Inventors: Aadhi ABDUL RAHIM, Montreal (CA); Luigi DI LAURO, Montreal (CA); Bennet FISCHER, Montreal (CA); Pavel DMITRIEV, Montréal (CA); Piotr ROZTOCKI, Longueuil (CA); Armaghan ESHAGHI, Kanata (CA); Yoann JESTIN, Montreal (CA); Roberto MORANDOTTI, Montreal (CA)

(73) Assignees: HUAWEI TECHNOLOGIES CANADA CO., LTD., Kanata (CA); Institut National de la Recherche Scientifique, Quebec City (CA)

(21) Appl. No.: 18/810,064

(22) Filed: Aug. 20, 2024

Related U.S. Application Data
(63) Continuation of application No. PCT/CA2022/050451, filed on Mar. 25, 2022.

(51) Int. Cl. G06N 3/067; G02F 1/35; G02F 1/365; G06N 3/048; G06N 3/049

(52) U.S. Cl. CPC G06N 3/0675; G02F 1/3507; G02F 1/3519; G02F 1/365; G06N 3/048; G06N 3/049

(57) ABSTRACT

A photonic device which is configured to implement a recurrent neural network via reservoir computing is provided. The device includes a feed portion which mixes an input signal with previously generated and controllably attenuated portions of an output signal. The device further includes one or more propagating stages coupled to the feed portion. Each propagating stage propagates signals through a loop in both clockwise and counterclockwise directions, for example to be affected by nonlinear elements. The arrangement of the photonic device causes a nonlinear activation function to be realized by the propagating stages. The nonlinear activation function may be adjustable by adjusting various controllable elements in the device.

### CROSS-REFERENCE TO RELATED APPLICATIONS

This application is a continuation of International Patent Application No. PCT/CA2022/050451, filed Mar. 25, 2022, entitled “Method and Apparatus for Optical Information Processing,” the contents of which are incorporated herein by reference in its entirety.

### TECHNICAL FIELD

This invention pertains generally to the fields of optical computing and neural networks, and in particular to methods and apparatus to implement optical computing in relation to reservoir computing for a recurrent neural network.

### BACKGROUND

Artificial neural networks (ANN) that are powered by machine learning (ML) algorithms can be used to tackle, with limited human oversight, complex problems in applied sciences, engineering and telecommunications. Two (not necessarily mutually exclusive) example implementations of ANNs include those featuring unidirectional processing of temporally static data, and those featuring feedback-based processing of temporally dynamic data, for instance, speech recordings. Unidirectional processing is often performed with feedforward neural networks (FNN) and convolutional neural networks (CNN), while feedback-based processing is often performed with recurrent neural networks (RNN).

Presently, the implementation of such ANNs architectures depends predominantly on digital electronics-based hardware, which is inherently limited by a “von Neumann bottleneck”, which refers to the limitations of conventional computing architectures, in terms of achievable transmission bandwidths, processing speeds, parallelization, and energy consumption. In order to support internet of things (IoT) applications and to train advanced ANNs, one or more of these limitations must be overcome.

A fully connected RNN consists of multiple (N) physical nonlinear nodes. The interconnections between RNN nodes can be nonlinear, and the design can include many nodes. One particular framework for designing an RNN, which potentially involves fewer components than other RNN configurations, (particularly when temporally multiplexed reservoirs are used) is known as reservoir computing (RC). The use of RC in an RNN can allow physical, and specifically photonic integration, as well as a simpler yet powerful approach to implement ML. An RC approach can establish for the RNN a network in a phase space, the nodes of which are virtual points having fixed and random interconnections (fixed random weights). The network of virtual points is the “reservoir” of RC and RC results can be used to train via ML the output nodes of the RNN.

An RC platform can allow applications such as image recognition (e.g. in the medical field), automatic speech analysis, real-time telecommunication signal processing, as well as the enablement of smart applications for the IoT.

Some RC architectures can be realized optically. Such designs involve different types of nonlinear nodes and activation functions, effectively corresponding to different nonlinear transformations for a sequence of input data.

Existing implementations related to RC include, for example, the single node concept (Appeltant, L., Soriano, M. C., Van der Sande, G., Danckaert, J., Massar, S., Dambre, J., Schrauwen, B., Mirasso, C. R., & Fischer, I. 2011. “Information processing using a single dynamical node as complex system.” Nat. Commun. 2, 468), injection locking of a semiconductor laser (Hou, Y., Xia, G., Yang, W., Wang, D., Jayaprasath, E., Jiang, Z., Hu, C., & Wu, Z. 2018. “Prediction performance of reservoir computing system based on a semiconductor laser subject to double optical feedback and optical injection.” Opt. Express 26, 10211-10219), semiconductor optical amplifiers and saturable absorbers (Dejonckheere, A., Duport, F., Smerieri, A., Fang, L., Oudar, J.-L., Haelterman, M., & Massar, S. 2014. “All-optical reservoir computer based on saturation of absorption.” Opt. Express 22, 10868 (2014), electro-optic modulators with electronic feedback (Larger, L., Baylón-Fuentes, A., Martinenghi, R., Udaltsov, V. S., Chembo, Y. K., & Jacquot, M. 2017. “High-Speed Photonic Reservoir Computing Using a Time-Delay-Based Architecture: Million Words per Second Classification.” Phys. Rev. X 7), and passive networks consisting of a fiber cavity and a photodiode implementing a nonlinearity (Vinckier, Q., Duport, F., Smerieri, A., Vandoorne, K., Bienstman, P., Haelterman, M. & Massar, S. 2015. “High-performance photonic reservoir computer based on a coherently driven passive cavity.” Optica 2, 438). For a fully connected RNN, many implementation focus on networks of connected semiconductor optical amplifiers (SOA) (Vandoorne, K., Dierckx, W., Schrauwen, B., Verstraeten, D., Baets, R., Bienstman, P., & Van Campenhout, J. 2008. “Toward optical signal processing using Photonic Reservoir Computing.” Opt. Express 16, 11182.

Potential drawbacks of photonic RNNs, including RC architectures, can include effects on encoding, read-out, stability, as well as limited processing capabilities and data rate capacities. Moreover, many RNN architectures are limited by design to tackle a particular category of ML problems (e.g., as limited by the capabilities of a static nonlinear activation function). Also, while a network of connected semiconductor optical amplifiers (SOA) can be powerful, it might require a large footprint and significant power consumption, compared to one having fewer nodes.

Particular drawbacks in existing implementations include the following. Because of inefficiencies in several electro-optical conversion steps or in input/output injection techniques, processing speeds can be too slow, hence too long latencies or feature excessive energy consumption for some applications. And because components for ML multitasking, or for realizing the deployment of a photonic RNN for parallel processing applications interfaced to a telecom network can be spectrally-limited, the potential application of photonic RNNs for IoT can be affected.

Therefore, to meet needs such as increasing processing speeds, reducing energy consumption, and using more of the spectral bandwidth allowed with a photonic RNN, there is a need for methods and apparatus to facilitate the implementation of a photonic-based RC, which obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Embodiments of the present disclosure provide for methods and apparatus for implementing optical computing. A photonic device which is configured to implement a recurrent neural network via reservoir computing is provided. The device includes a feed portion which mixes an input signal with previously generated and controllably attenuated portions of an output signal to create a feedback loop. The device further includes one or more propagating stages coupled to the feed portion. Each propagating stage propagates signals through a loop in both clockwise and counterclockwise directions, to be affected by nonlinear elements. The arrangement of the photonic device causes a nonlinear activation function to be realized by the propagating stages. The nonlinear activation function may be adjustable by adjusting various controllable elements in the device.

According to some embodiments, there is provided a photonic apparatus. The apparatus may include some or all of an input terminal configured to receive an optical input signal, a propagating stage, an interface portion, a feed portion and an output terminal. According to various embodiments, the apparatus includes at least the propagating stage. The propagating stage includes a set of components arranged along and forms a single bidirectional optical pathway between a first terminal and a second terminal. The propagating stage is configured to propagate a first optical signal along the optical pathway in a first direction from the first terminal to the second terminal to be affected by the set of components in a first manner to produce an affected version of the first optical signal. The propagating stage is further configured to propagate a second optical signal along the optical pathway in a second (opposite) direction from the second terminal to the first terminal to be affected by the set of components in a second manner different from the first manner to produce an affected version of the second optical signal. The set of components of the propagating stage is configured to produce a nonlinear relationship between the intermediate optical signal and the resultant optical signal. The nonlinear relationship assists in providing a nonlinear activation function of the photonic apparatus operating to implement one or more reservoir computing nodes of a recurrent neural network. The interface portion is configured to: receive an intermediate optical signal which comprises the optical input signal; provide, to the first terminal of the propagating stage, the first optical signal as a first portion of the intermediate optical signal; provide, to the second terminal of the propagating stage, the second optical signal as a second portion of the intermediate optical signal; receive the affected version of the first optical signal from the second terminal of the propagating stage; receive the affected version of the second optical signal from the first terminal of the propagating stage; and combine, via optical interference, the affected version of the first optical signal with the affected version of the second optical signal to form a resultant optical signal. The feed portion is configured to: receive the optical input signal from the input; receive a portion of the resultant optical signal; using a controllably variable amount of attenuation, produce an attenuated version of said portion of the resultant optical signal; and combine the optical input signal with the attenuated version of said portion of the resultant optical signal to generate the intermediate optical signal. The output terminal is configured to provide another portion of the resultant optical signal.

A potential technical effect is that the photonic apparatus provides, using a particular arrangement of photonic components, an effective device for use in photonic computing, particularly for implementation of an artificial neural network, such as a recurrent network, for example using reservoir computing. The photonic apparatus potentially provides for one or more nonlinear activation functions which may be adjustable, and which facilitate effective reservoir computing and neural network implementations. The bidirectional counter-propagation of signals in the propagating stage, together with the feedback implemented using the feed portion, assists the photonic apparatus to be useful in this manner.

In various embodiments, the amount of attenuation is controllably variable to implement a controlled variation of the nonlinear activation function. The controlled variation may include a controlled variation in nonlinearity characteristics of the nonlinear activation function. Thus, the photonic apparatus can be tuned or adjusted for different use cases.

In various embodiments, the set of components of the propagating stage includes a spiral waveguide operating as a nonlinear component contributing to providing said nonlinear activation function. The spiral waveguide may be a nonlinear waveguide. Thus, a passive and compact nonlinear element contributing to the nonlinear activation function may be provided for.

In various embodiments, the set of components of the propagating stage further comprises a controllable gain element. The controllable gain element may cooperate with additional members of the set of components to provide the nonlinear activation function as a controllable nonlinear activation function. This provides for further control and customization of the apparatus.

In various embodiments, the feed portion establishes a first optical signal loop, the propagating stage establishes one or more second optical signal loops coupled to the first optical signal loop, and the first optical signal loop and the one or more second optical signal loops are cooperatively configured to provide a delayed feedback facilitating implementation of said reservoir computing nodes.

In various embodiments, the propagating stage and the interface portion together form a nonlinear amplifying loop mirror or a nonlinear optical loop mirror.

In various embodiments, the interface portion is an optical coupler having at least two inputs and at least two outputs. Thus, optical signals can be readily split and combined using an established device.

In various embodiments, the photonic apparatus further includes a plurality of propagating stages including the propagating stage. Each of the plurality of propagating stages has substantially a same or similar general structure and configuration as the propagating stage. Multiple propagating stages increases the possibilities for customizing the activation function and nonlinear effects that the propagating stage has on optical signals. This can increase the applicability or versatility of the photonic apparatus for use in neural network implementations.

In various embodiments, the interface portion is configured to operatively couple the feed portion to at least two of the plurality of propagating stages in a same manner as the interface portion operatively couples the feed portion to the propagating stage to implement a parallel arrangement. In various embodiments, the interface portion is configured to combine outputs of each of said at least two of the plurality of propagating stages together to produce the resultant signal.

In various embodiments, different respective outputs of said at least two of the plurality of propagating stages are received at different times due to different respective delays of said at least two of the plurality of propagating stages, and wherein said combining outputs comprises a temporal concatenation of the different respective outputs of said at least two of the plurality of propagating stages. In various embodiments, combining outputs comprises a wavelength division multiplexing of the different respective outputs.

In various embodiments, the plurality of propagating stages includes a second propagating stage operatively coupled to the propagating stage in a series arrangement.

In various embodiments, the plurality of propagating stages are configured in a series arrangement, a parallel arrangement, or a series-parallel arrangement. Accordingly, various different options are provided for increasing the versatility of the photonic apparatus.

In various embodiments, the optical input signal comprises multiple sub-signals each limited to a different respective wavelength band, the apparatus configured to process the multiple sub-signals in parallel via wavelength division multiplexing. Accordingly, the photonic apparatus can be used to process multiple signals concurrently, utilizing a significant photonic bandwidth to speed up computations.

In various embodiments, the set of components of the propagating stage includes a controllable bi-directional amplifier. This provides a further point of control for customizing the photonic apparatus, increasing versatility.

In various embodiments, the set of components of the propagating stage includes one or more of: a spiral waveguide with nonlinear optical characteristics; a waveguide with nonlinear characteristics; a microring resonator with nonlinear characteristics; a photonic crystal optical fiber or waveguide with nonlinear characteristics; and an optical fiber with nonlinear characteristics.

According to some embodiments, there is provided a method. The method includes receiving, at an input terminal of a photonic apparatus, an optical input signal. The method includes, at a propagating stage of the photonic apparatus (the propagating stage comprising a set of components arranged along and forming a single bidirectional optical pathway between a first terminal and a second terminal): propagating a first optical signal along the optical pathway in a first direction from the first terminal to the second terminal to be affected by the set of components in a first manner to produce an affected version of the first optical signal; and propagating a second optical signal along the optical pathway in a second direction from the second terminal to the first terminal to be affected by the set of components in a second manner different from the first manner to produce an affected version of the second optical signal. The set of components of the propagating stage produce a nonlinear relationship between the intermediate optical signal and the resultant optical signal, said nonlinear relationship providing a nonlinear activation function of the photonic apparatus operating to implement one or more reservoir computing nodes of a recurrent neural network. The method further includes, at an interface portion of the photonic apparatus: receiving an intermediate optical signal which comprises the optical input signal; providing, to the first terminal of the propagating stage, the first optical signal as a first portion of the intermediate optical signal; providing, to the second terminal of the propagating stage, the second optical signal as a second portion of the intermediate optical signal; receiving the affected version of the first optical signal from the second terminal of the propagating stage; receiving the affected version of the second optical signal from the first terminal of the propagating stage; and combining, via optical interference, the affected version of the first optical signal with the affected version of the second optical signal to form a resultant optical signal. The method further includes, at a feed portion of the photonic apparatus: receiving the optical input signal from the input; receiving a portion of the resultant optical signal; using a controllably variable amount of attenuation, producing an attenuated version of said portion of the resultant optical signal; and combining the optical input signal with the attenuated version of said portion of the resultant optical signal to generate the intermediate optical signal. The method further includes, at an output terminal of the photonic apparatus, providing another portion of the resultant optical signal. Various other aspects of the method may be provided for, commensurate with the embodiments of the photonic apparatus as already described above. According to embodiments, the method includes at least the operations of the propagating stage.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a basic artificial neural network (ANN) the input of which is encoded information.

FIG. 2A illustrates a neural network with a reservoir.

FIG. 2B illustrates a reservoir computing implementation of a neural network.

FIG. 3 illustrates a functional block diagram of an apparatus provided according to embodiments of the present disclosure, which may be used to implement a neural network via reservoir computing, and in which a reservoir implements a nonlinear activation function using optical components.

FIG. 4A illustrates a schematic block diagram showing an implementation of the apparatus of FIG. 3, according to embodiments of the present disclosure, with potentially multiple propagating stages.

FIG. 4B illustrates a series configuration for a plurality of propagating stages, according to embodiments of the present disclosure.

FIG. 4C illustrates a parallel arrangement for a plurality of propagating stages, according to embodiments of the present disclosure.

FIG. 4D illustrates a mixed series-parallel arrangement for a plurality of propagating stages, according to embodiments of the present disclosure.

FIG. 4E illustrates multiple propagating stages coupled together in one form of series-parallel arrangement 490, also referred to as a hybrid arrangement, according to embodiments of the present disclosure.

FIG. 5A illustrates a particular implementation of FIG. 4A, including a nonlinear amplifying loop mirror (NALM) as the single propagating stage.

FIG. 5B illustrates particular implementation of the apparatus of FIG. 5A.

FIG. 5C is a graph showing a nonlinear activation function as can be implemented by an embodiment.

FIG. 6A is a graph sampling the Mackey-Glass time-series, as was used to test the performance of a device according to an embodiment.

FIG. 6B is graph representing a 20-level random mask that can be applied to the Mackey-Glass time series of FIG. 6B, before it is encoded and provided as an optical input signal to a device according to an embodiment.

FIG. 6C is a graph of the Mackey-Glass time-series of FIG. 6A, after being processed by the mask of FIG. 6B, and as it can be encoded as an optical input signal to test a device according to an embodiment.

FIG. 7A is a graph showing the results of a Mackey-Glass time series prediction, according to an embodiment.

FIG. 7B is a graph showing the weight by each virtual point of a phase space, as determined by a Ridge regression, of a device according to an embodiment.

FIG. 7C illustrates normalized mean squared error (NMSE) values for various value combinations of two gain parameters, according to an example embodiment.

FIG. 8 illustrates a scheme for optically processing data in parallel, according to an embodiment.

FIG. 9A is a spectrum of optical wavelengths encoding data representing two independent tasks, in order to demonstrate parallel processing of two independent tasks according to an embodiment.

FIG. 9B is a spectrum of optical wavelengths encoding data from a single task, but split in two data channels, in order to demonstrate parallel processing of two data channels of a same task, according to an embodiment.

FIG. 10A is a graph showing the results from an offline training operation on the two data sets of FIG. 9A, according to an embodiment.

FIG. 10B is a graph showing the results from an offline training operation on the two data sets in FIG. 9b, according to an embodiment.

FIG. 11A is a spectrum including 9 frequency channels onto which 1200 bits of information are encoded, in order to perform a PAM4 signal recovery task to test an embodiment.

FIG. 11B shows a recovered PAM4 signal over the first 100 bits, after an offline training operation, according to an embodiment.

FIG. 11C shows the bit error rate (BER) of the recovered PAM4 signal over the first 100 after offline training, shown in FIG. 8B, according to an embodiment.

FIG. 12 shows reconstructed eye diagrams obtained for 3 channels of FIG. 11A. of the 9 channels.

### DETAILED DESCRIPTION

In order to support applications demanding data processing with high speeds, low latencies, and high bandwidth and channel capacity, a photonics-based ANN can be employed. The applications addressed can arise for example from advancements in telecommunication networks (e.g., 5G), where real-time ML solutions, particularly using RNN architectures for data processing, are needed. Existing photonics-based RNNs can lack parameters that are readily tunable for performing different, parallel tasks of varying complexity. Furthermore, providing for nonlinear nodes in a photonics-based RNN can be technically challenging.

Embodiments of the present disclosure include methods and apparatus for optically processing data with photonic RNN schemes having a significantly higher processing speeds and data rate capacities than alternatives, by integrating parallel information encoding methods with photonic RNNs, in one or more devices. The RNN can be implemented using a photonic reservoir computing (RC) apparatus.

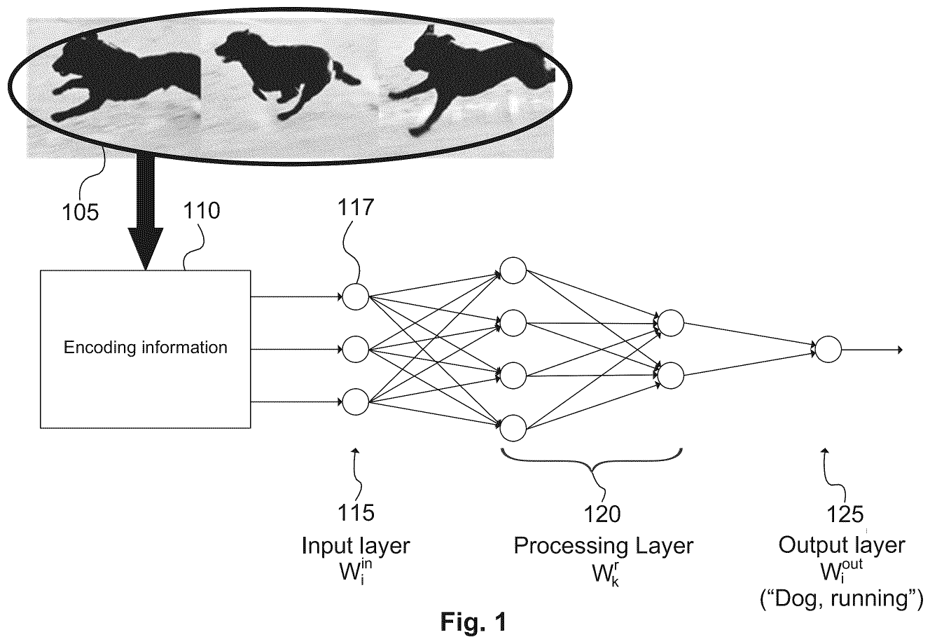

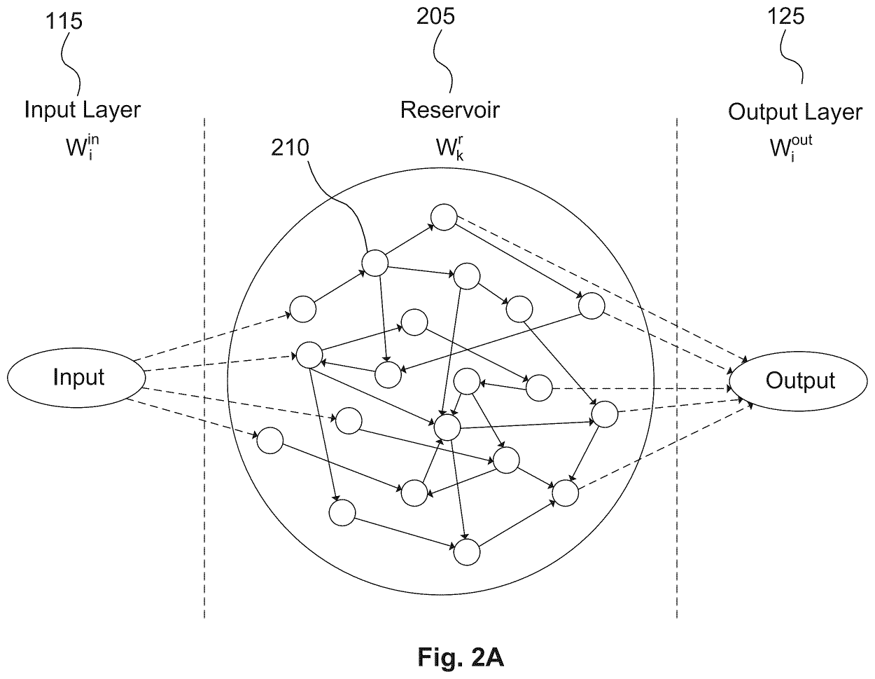

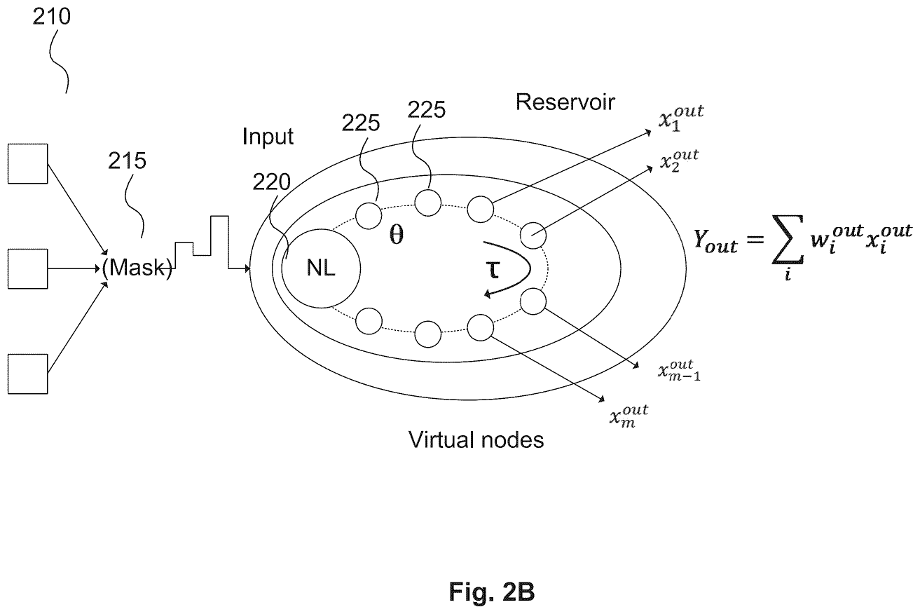

For context, FIG. 1 illustrates an example ANN with encoded input information. Information describing a series of images 105 can be encoded 110 in an input layer 115 of a neural network architecture applying input weights Wᵢⁱⁿ, to nodes 117 and be processed in a processing layer 120 applying processing layer (reservoir) weights Wₖ^{r}. An output layer 125 applying processing layer weights Wᵢ^{out} can produce a result such as, for example, an image recognition indication. The processing layer can be a RNN and may include a reservoir in accordance with known reservoir computing (RC) techniques. For example, it has been established (see e.g. “Information processing using a single dynamical node as a complex system,” L. Appeltant et al., Nature Communications, September 2011) that a single nonlinear node implementing delayed feedback can be used to produce a set of virtual nodes which can be used to constitute a reservoir of nodes. This reservoir of nodes can be used to implement an ANN such as an RNN according to known techniques. An example of a RC configuration is shown in FIG. 2A as detailed elsewhere below.

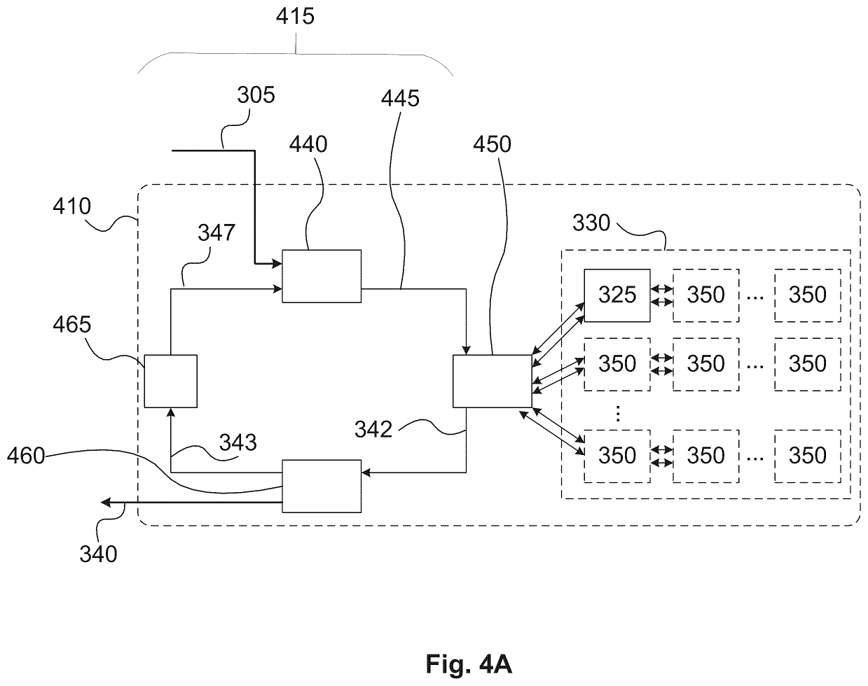

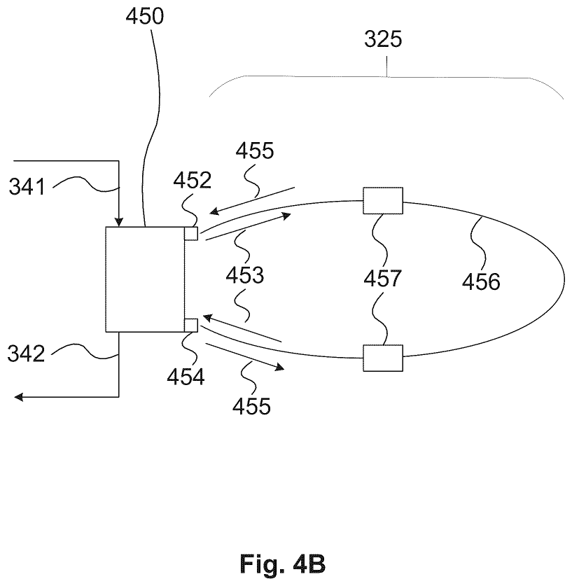

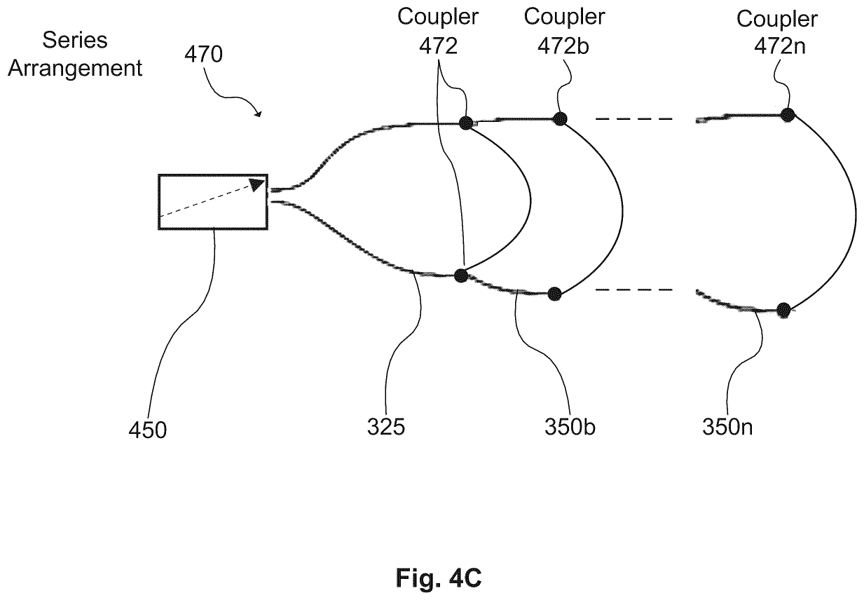

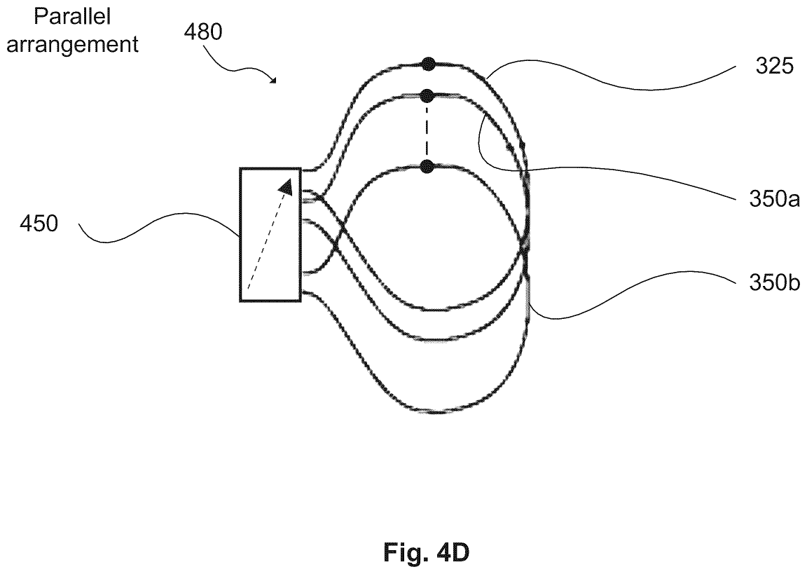

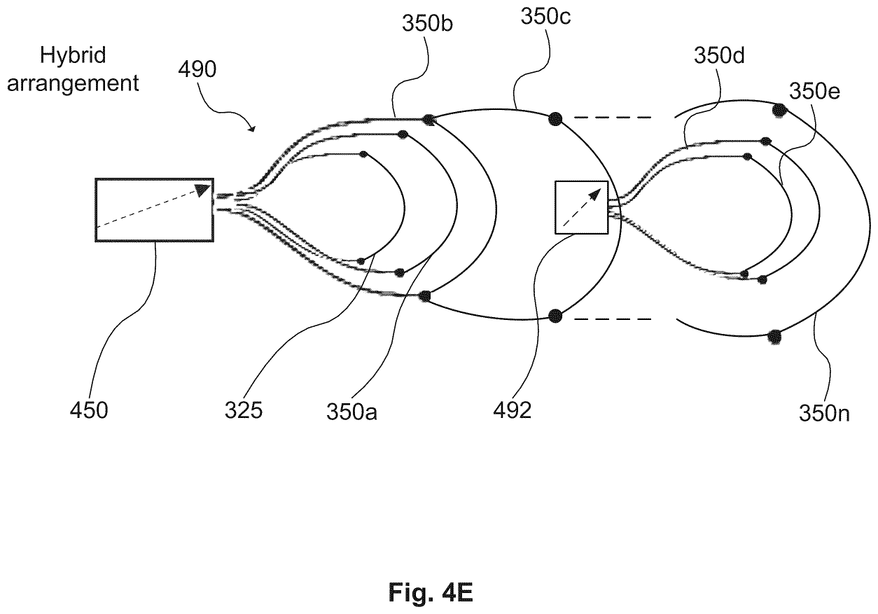

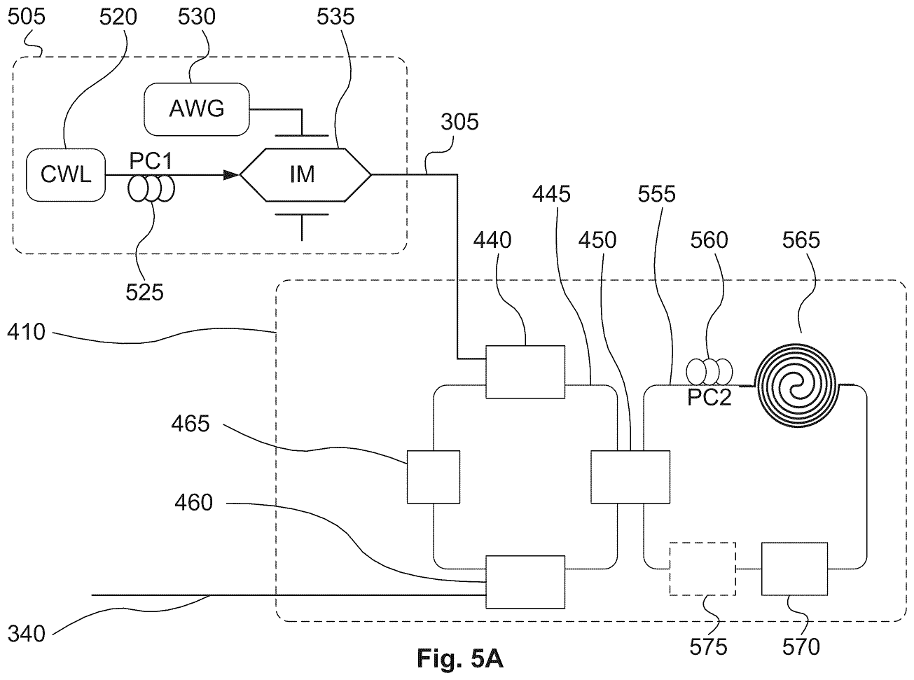

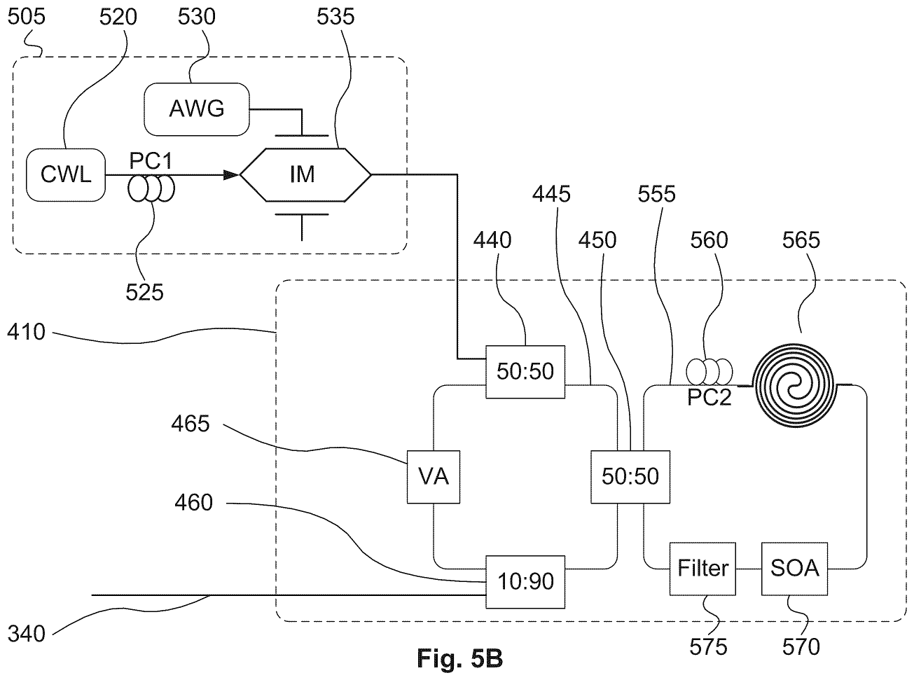

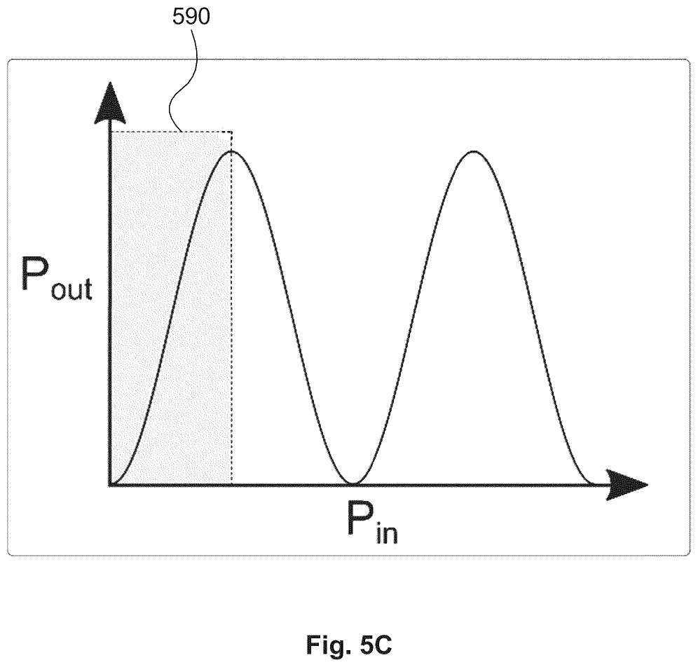

To potentially exceed the performance of conventional photonic RNN solutions, for example for processing large amounts of data exchanged by IoT applications over telecommunication networks, embodiments of the present disclosure can provide an all-optical processing device having two optical loops, coupled for example in a figure-8 configuration (see e.g. FIG. 4B), and performing as a nonlinear feedback loop. The optical loops can include optical fiber components or other optical waveguides, as well as other components such as amplifiers, attenuators, nonlinear waveguides, tunable delay lines, polarization controllers, etc. A basic operation principle of a device performing ML or neural network computing tasks according to some embodiments involves an encoded optical signal being split into a clockwise (CW) propagating signal and counter-clockwise (CCW) propagating signal. The CW and CCW propagating signals undergo a dissimilar nonlinear phase shift, and then recombine to form one resultant optical signal. This results in a nonlinear activation function being applied to the encoded optical signal (see e.g. FIG. 5C). The CW and CCW propagating signals can be referred to as counter-propagating signals. The loop through which the counter-propagating signals travel can be similar to the loop of a Sagnac interferometer (without Sagnac's original requirement of physical rotational motion). The propagating stage which implements this loop can be viewed as being nested within a cavity feedback loop. Multiple such propagating stages can be present and arranged in a serial, parallel, or combined series-parallel arrangement. An activation function may be a type of transfer function, such as a decision-making function that defines the nonlinear decision boundary in the input space by establishing a threshold for its internal values reached. An activation function Y may be a property of each respective node of an ANN, and generally, different nodes can have different activation functions. Assuming that all the nodes (neurons) have the same activation function, one can say that the activation function of the entire ANN is Y.

The encoded optical signal can be an intermediate optical signal which is generated by combining an optical input signal (e.g. from a modulated laser source) with previously provided portions of the ongoing resultant optical signal. This feedback, along with delays introduced by optical components, (such as waveguides which may be fiber-based or integrated into a photonic circuit) can provide for delayed feedback (e.g. of the cavity feedback loop) which can facilitate reservoir computing as mentioned above and as described below generally at least with respect to FIGS. 2A and 2B.

The use of a coupled loop (e.g. figure-8) configuration allows the apparatus to be operated in different operational regimes. Strong nonlinearity in the propagating stage, as well as the access to different operational regimes potentially makes the apparatus, viewed as a RC platform, more versatile and efficient relative to existing approaches. This can be due for example to the presence of a controllable gain or attenuation in each loop, allowing for versatile control of the gain/loss dynamics. This can be tuned according to the complexity and degree of non-separability required by a specific ML task.

For example, a coupled loop configuration can include a first optical signal loop established by a feed portion and one or more second optical signal loops coupled to the first optical signal loop, established by propagating stages. The first optical signal loop and the one or more second optical signal loops are cooperatively configured to provide a (e.g. delayed feedback) facilitating implementation of RC nodes. The amount of delay can be due to the presence and behaviors of components in both loops.

Embodiments of the present disclosure include a device based on a coupled loop configuration having one or more propagating stages. Different configurations of the propagating stage(s) are possible. Variations among embodiments include the number of propagating stages, their configurations, their topology, their interconnections (e.g. series, parallel, or series-parallel arrangements), methods for controlling optical gain, components used to stabilize feedback in a propagating optical signal, configurations for input and output modules, and optical components used to implement a nonlinear activation function in the device or to adjust it, or the like, or a combination thereof.

For further context, in RC, a reservoir can be positioned between an input layer and an output layer, and it can apply reservoir weights Wₖ^{r} to data being processed. While a typical neural network process can be configured as a layer, a reservoir can be configured otherwise.

FIG. 2A illustrates a neural network with a reservoir. A reservoir 205 is placed (instead of a processing layer 120) between an input layer 115 and an output layer 125 of the neural network. The configuration of its nodes 210 can be other than layered and a random but fixed configuration is shown in FIG. 2A. Depending on how a mathematical operation at each node is defined, it can be useful to consider the reservoir 205 to be a network of virtual points in a phase space.

In embodiments, the reservoir 205 can be implemented using optical components cooperatively configured to implement a nonlinear activation function, typically along with delayed feedback. This can assist in performing machine learning tasks in a recurrent neural network.

FIG. 2B illustrates a particular reservoir computing implementation of a neural network. Inputs 210 can be masked 215 and provided for example in a time-multiplexed manner to a nonlinear device (represented as nonlinear (NL) node 220) operating to implement a plurality of virtual reservoir computing nodes 225. The virtual reservoir computing nodes 225 may be implemented based on nonlinear characteristics of a single physical node 220, for example using multiplexing and masking 215. The virtual nodes (N=τθ) may be established using delayed feedback, which may also be responsible for a fading memory characteristic. This implementation is based on the loop mirror configuration (a temporally multiplexed reservoir) with potential advantages of coherence and tunability for a neural network using only a limited number of components. The output states Xᵢ^{out} from the reservoir nodes collected for every time interval θ are weighted by Wᵢ^{out} and integrated over every round trip time τ to produce the resulting outputs sequence Y.

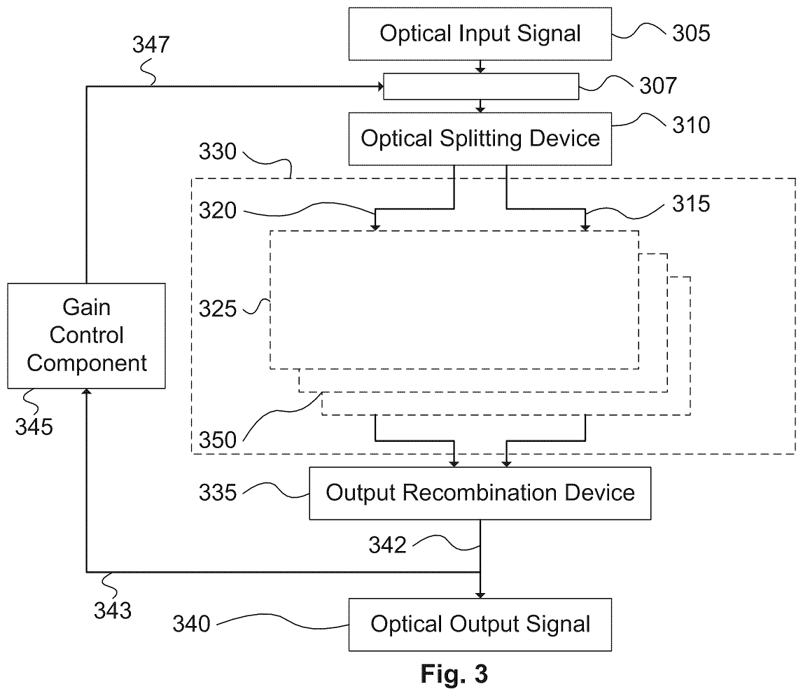

In a device according to embodiments, different channels can be implemented by having multiple propagating stages, different lengths in each propagating stage, different loop configurations, such as a nonlinear amplifying loop mirror (NALM) configuration, a nonlinear optical loop mirror (NOLM) configuration, and others, as well as combinations thereof. The NALM and NOLM configurations can differ primarily in that the NOLM configuration lacks gain control in the Sagnac loop. Some or all of the configurations can include tunable parameters that allow tuning the performance depending on a task. According to embodiments, an optical input signal can be an optical pulse that is split at an optical splitting device (e.g. device 310 of FIG. 3 as described below). Each one of the two pulses can counter-propagate through a nonlinear loop, and one pulse can undergo a greater nonlinear phase shift than the other pulse. Then, both pulses can be recombined at the optical recombination device (e.g. device 335 of FIG. 3) which may be integrated with the optical splitting device. This different nonlinear treatment of each of the counter-propagating signals, along with the optical recombination, can be used to implement a nonlinear activation function of a RC apparatus.

FIG. 3 illustrates a functional block diagram of an embodiment of the present disclosure, in which a coupled loop configuration is implemented with optical components. The apparatus can be used to implement reservoir computing with a nonlinear activation function and controllable feedback. An optical input signal 305 carrying data is combined, at optical combiner 307 (or alternatively at the optical splitting device 310), with a feedback optical signal 347 to generate an intermediate optical signal. The intermediate optical signal is divided, by an optical splitting device 310, into two portions, namely a CW propagating signal 315 (also called a first optical signal) and a CCW propagating signal 320 (also called a second optical signal). The two signals 315 and 320 are provided to a propagating stage 325. The propagating stage 325 includes a set of components which can be implemented in a loop configuration.

The two signals recombine at an optical recombination device 335 to produce a resultant optical signal 342. A portion of the resultant optical signal can be provided at an output terminal, as an optical output signal 340. Another portion 343 of the resultant optical signal can be returned to provide the feedback optical signal, to be combined with the optical input signal 305 to generate the intermediate optical signal. Specifically, a gain control component 345, such as a controllable attenuator (variable attenuator), receives this other portion 343 of the resultant optical signal and produces an attenuated version of this other portion of the resultant optical signal as the feedback optical signal 347. The gain control component 345 can possibly be a controllable amplifier, although an attenuator is typically assumed herein. It is noted that gain of less than unity (or negative gain on a logarithmic scale) is referred to as attenuation. The combination occurs at the optical combiner 307, which may be an optical coupler having two connected inputs and one connected output. This allows for a feedback loop having the gain control component 345. The gain control component may provide an attenuation that controls the gain of the feedback.

A principle of operation in the above apparatus is that portions of the optical input 305 can propagate via a CW propagating signal 315 and a CCW propagating signal 320, which can be phase-shifted separately and nonlinearly. When recombined at device 335, the phase mismatch (related to the phase difference between signals 315 and 320) of the resultant optical signal, which includes the optical output signal 340, can be adjusted nonlinearly. In various embodiments, the phase mismatch is an intensity induced phase difference between CW and CCW propagating signals. The difference in intensity of CW and CCW propagating signals (due to one signal experiencing gain before the other), can lead to different amount of phase shift for the CW and CCW propagating signals.

Although only a single propagating stage 325 is discussed above, a plurality (two, three, or more) of propagating stages can be provided, as represented by stacked boxes 325 and 350 in FIG. 3. These propagating stages provide for a nonlinear device or node of the reservoir computing implementation. The optical splitting device can send CW and CCW propagating signals to each of these propagating stages cither directly or indirectly, and the output recombination device 335 can similarly receive (from each such propagating stage) and recombine respective affected versions of these CW and CCW propagating signals. The single propagating stage or the plurality of propagating stages, as the case may be, can be used to implement a nonlinear activation function 330 of an RNN such as a RC implementation of the RNN. The gain control component 345 can further adjust the behavior of the nonlinear activation function 330, for example by causing the components of the nonlinear activation function to operate in different parts of a nonlinear regime.

The various possible phase mismatches produced by the propagating stage 325 (or stages 325, 350) implementing a nonlinear activation function 330 allow for different nonlinearities inside the network. The various possible phase mismatches with respect to each node can be treated as RC outputs that can be used to implement a RNN according to ML.

The nonlinear activation function can be implemented by the specific configuration or components of the propagating stage 325 or collection of stages 325, 350, including one or more loops, serial or parallel interconnections, and a variety of optical components to sustain the propagation of CW and CCW signals. Multiple stages 325, 350, can be provided in series, parallel, or a substantially arbitrary series-parallel arrangement. The nonlinear activation function of the photonic apparatus is thus provided at least in part by the set of components (e.g. nonlinear components) of the propagating stages. In more detail, this nonlinear activation function corresponds to a nonlinear relationship between the intermediate optical signal and the resultant optical signal. The nonlinear activation function thus allows the photonic apparatus to operate to implement one or more reservoir computing nodes of a recurrent neural network. The propagating stages can generally have a same structure and configuration as one another, that is being loops allowing for counter-propagating signals. At the same time, each propagating stage can have different elements or differently configured versions of the same elements.

One component of a propagating stage potentially contributing to the nonlinearity of the activation function is an elongated nonlinear element, such as an elongated (e.g. spiral) waveguide. The waveguide itself can be made of a particular material making it a nonlinear waveguide. That is, the elongated nonlinear element can operate as a nonlinear component. The elongation may increase the amount of per-unit-length nonlinearity of the waveguide. Furthermore, the elongated nonlinear element may cause at least a predetermined amount of delay in the optical signals propagating through it in either direction. Additionally or alternatively, the propagating stage can include a spiral waveguide with nonlinear operating characteristics, an (e.g. elongated in another manner) waveguide with nonlinear characteristics, a microring resonator with nonlinear characteristics, a photonic crystal optical fiber or waveguide with nonlinear characteristics, an optical fiber with nonlinear characteristics, or the like, or a combination thereof. Such components can cause delay, nonlinearity, or both. Components can cause phase shifts in signals propagating through same, for example with the amount of phase shift induced in signals propagating through the component in one direction being different than the amount of phase shift induced in signals propagating through the component in the opposite direction. In some embodiments, the material of such a component can have a nonlinear response to an applied optical field, which may be an intensity dependent effect. For example a spiral (nonlinear) waveguide may have a cubic nonlinearity, for example in that the nonlinear phase shift is an intensity dependent effect according to a cubic function.

Accordingly, a nonlinear component, such as a nonlinear waveguide, can change the phase difference due to its intensity difference and the output changes accordingly. The phase and the intensity have one to one correspondence, so that one can use either phase or intensity. In other words, the output of the nonlinear component can be characterized as a nonlinear function of the input field E, having output intensity I α χ⁽³⁾|E|².

Another component of a propagating stage potentially contributing to the nonlinearity of the activation function is a controllable gain element, such as an amplifier (e.g. SOA). The controllable gain element can cooperate with the elongated nonlinear element to provide (or contribute to providing) the nonlinear activation function. Furthermore, because the gain element is controllable, the nonlinear activation function is controllable, for example in terms of nonlinearity characteristics (shape of input-output relationship curve) thereof. In some embodiments, a (e.g. bandpass) filter can be included with the controllable gain element to mitigate introduced noise. The amplifier can be a controllable bi-directional amplifier, e.g. an amplifier configured to amplify signals passing through same in either direction. In some embodiments, a signal passing through the amplifier in one direction can be amplified by a same amount as a signal passing through the amplifier in an opposite direction. In some embodiments, a signal passing through the amplifier in one direction can be amplified by a different amount than a signal passing through the amplifier in an opposite direction.

The configuration of a propagating stage 325 or 350, or a collection of such propagating stages, can allow a device to be adapted to perform a particular ML task. The gain of the gain control component 345 can be controllably adjusted to allow processing to be adjusted as required. For example, adjusting of the overall gain of the reservoir through the gain control component 345 can cause the propagating stages 325, 350 to operate in different dynamic regimes, adjusting the amount of delayed feedback to control the feedback strength and modulate the dynamic regimes. For example, the amount of attenuation implemented by the gain control component can be controllably variable to implement a controlled variation in a nonlinear activation function of the apparatus. This can be a controlled variation in nonlinearity characteristics (e.g. shape of a nonlinear input-output relationship) of the nonlinear activation function.

Possible configurations of a propagating stage 325 (or 350) include a NALM and a nonlinear optical loop mirror (NOLM), either of which can be realized with serial or parallel connections, using multi-port couplers. Propagating signals can be split and recombined into different channels. For instance, an optical splitting device 310 or an optical recombination device 335 can be an N×M coupler (possibly with N=M), using either power splitters or frequency splitters, such as wavelength division multiplexing (WDM) couplers and multimode interference couplers.

In a NALM configuration, a nonlinear activation function can be implemented with a nonlinear optical waveguide. However, other components can be used, such as a nonlinear optical fiber, a photonic crystal fiber, a liquid core fiber, or a very long standard optical fiber. If needed, a gain control component can contribute additional nonlinearity, by increasing gain β of a feedback loop. Feedback tuning can improve a device's ability to solve ML tasks having more nonlinearity. Attenuation α may be associated with the attenuation of the feed portion through the gain control element, which affects to the overall gain of the reservoir. Gain β may be associated with the gain within the propagating stage, which can provide for additional nonlinearity that may be needed to perform machine learning tasks.

Embodiments also include a NOLM configuration, which unlike a NALM configuration, is passive. This can be desirable where a simplified device is sufficient or high energy efficiency is required. In some embodiments, the NOLM configuration can be provided for by setting the gain of an optical amplifier (or optical attenuator, or combination amplifier/attenuator), disposed within the propagating stage, to either unity or less than unity. In some embodiments, if only the NOLM configuration is required in a particular propagating stage, that propagating stage may be outfitted with a variable (or fixed) attenuator rather than an amplifier, or possibly no attenuator at all.

In both NALM and NOLM configurations, optical input signals 305 and optical output signals 340 (see e.g. FIG. 5A) can enter and exit a device with optical couplers.

As will become apparent below, the optical splitting device 310 and the output recombination device 335 can be combined into a single device, such as an optical coupler or more generally an interface portion device 450. The optical splitting device and output recombination device, or the associated optical coupler, can not only split optical signals into CW and CCW propagating signals and recombine same, but can also split optical signals into multiple different pairs of CW and CCW propagating signals (and recombine same), each pair being provided to and received from a different propagating stage (325, 350) of the overall nonlinear activation function 330.

FIG. 4A illustrates a photonic apparatus 410 according to an embodiment of the present disclosure, which may be used to implement the functional block diagram of FIG. 3. The apparatus includes an input terminal configured to receive an optical input signal 305. The apparatus further includes a feed portion 415 (including at least components 440, 465) which is configured to receive the optical input signal 305 from the input terminal and generate an intermediate optical signal based at least in part on the optical input signal. Components 465 and 345 may be equivalent. Generation of the intermediate optical signal is performed by an optical coupler 440 which receives both the optical input signal 305 and a feedback signal 347 and combines (couples) these two signals together to generate the intermediate optical signal. The intermediate optical signal is then provided to an interface portion 450, which can be an N× M optical coupler, where N is equal to or unequal to M, or another suitable device such as a multiplexer, demultiplexer, a device routing different optical frequencies to different spatial paths, or combining different spectral paths into a single path, programmable filter, etc. The interface portion 450 provides first and second optical signals (i.e. CW and CCW propagating signals) to one or more propagating stages 325, 350 of the overall nonlinear activation function 330.

The interface portion 450 also receives affected versions of the first and second optical signals which are outputs of the propagating stages 325, 350, or more generally outputs of the nonlinear activation function 330. These affected versions correspond to outputs of the propagating stages in response to the first and second optical signals being input and affected by the various components (e.g. nonlinear waveguides, amplifiers) of the propagating stages. The interface portion 450 combines, via optical interference, the affected versions of the first and second optical signals to form a resultant optical signal 342.

In more detail, each propagating stage 325, 350 may output a pair of signals, namely a respective affected version of a first optical signal and an affected version of a second optical signal. The interface portion 450 then receives combines these two signals. Moreover, when there are multiple propagating stages, the interface portion 450 may receive and combine a different pair of such signals from every propagating stage, and may also combine together each such pair of signals into a resultant optical signal 342. That is, outputs of each of a plurality of propagating stages can be combined together to produce the resultant signal. This combination may be via operation of an N×M coupler with the M ports viewed as inputs receiving the pairs of signals and one of the N ports providing the resultant optical signal 342. The resultant optical signal 342 is routed toward an output port which provides at least a portion of the resultant optical signal as an optical output signal 340. As illustrated, to implement this, the interface portion 450 provides the resultant optical signal to an optical coupler 460, such as a 1×2 optical coupler, which splits the resultant optical signal 342 into two portions-one portion is provided (at an output terminal) as an optical output signal 340 and another portion 343 is used to generate the feedback signal 347 which is combined with the optical input signal 305 at the optical coupler 440, as described above. An attenuator 465 may be provided and used to attenuate this other portion 343 of the resultant optical signal. The gain of the attenuator 465 may be controllably variable, for example via an input control voltage. As such, the feed portion receives, at 465, a portion 343 of the resultant optical signal, and produces an attenuated version of this portion 343 of the resultant optical signal, which is also referred to as the feedback signal 347. This can be performed using a controllably variable amount of attenuation, for example as implemented by an optically or electronically controlled variable attenuator. As stated above, the feed portion combines, at 440, the optical input signal with the feedback signal 347 to generate the intermediate optical signal.

It is noted that combining of affected versions of first (CW) and second (CCW) optical signals can include combining two versions of an original signal which are substantially phase-shifted versions of one another (although other differences may exist). This combining of phase-shifted signals may cause or contribute to the nonlinearity of the propagating stages.

As illustrated, the interface portion 450 can be coupled to one, two or more propagating stages 325, 350, but is not necessarily coupled directly to all of the propagating stages. A leftmost column 352 of propagating stages is shown as being coupled to the interface portion 450, and these propagating stages can be said to be coupled in parallel to the interface portion. In some embodiments, if there are M/2 propagating stages in the column 352 then the interface portion may be an N×M optical coupler, with two of the M ports coupled to each of the M/2 propagating stages. One, some or all of these propagating stages which are directly coupled to the interface portion can themselves be coupled to further propagating stages. A chain of two or more propagating stages coupled in this manner (e.g. in a row 354 of propagating stages) can be said to be coupled in series to the interface portion. Although in FIG. 4A each parallel propagating stage is shown as being coupled to a single chain of successive propagating stages in series, this is just one of a variety of possible series-parallel arrangements. In other embodiments, one propagating stage can be coupled in series to two or more propagating stages which are themselves parallel to one another. Further, different chains or arrangements of propagating stages can have different numbers of propagating stages, different topological arrangements, etc. Further, different chains or parallel propagating stages can be cross-coupled to one another. Thus, a plurality of propagating stages can be interconnected to one another in a variety of ways, which are all considered to be different series-parallel arrangements.

In more detail, and with reference to FIG. 4B, the interface portion 450, which may be an optical coupler, is configured to receive the intermediate optical signal 341 (which comprises the optical input signal). For clarity, only one propagating stage 325 is shown in FIG. 4B. The interface portion 450 is further configured to provide, to a first terminal 452 of each propagating stage, a respective first optical signal 453 which is a first portion of the intermediate optical signal. The interface portion is further configured to provide, to a second terminal 454 of each propagating stage, a respective second optical signal 455 which is a second portion of the intermediate optical signal. As the propagating stage 325 is configured substantially as a loop, the first terminal 452 acts as an input (to the propagating stage) for the first optical signal 453 and also acts as an output (from the propagating stage) for the second optical signal 455 (after it has been affected by the propagating stage). Similarly, the second terminal 454 acts as an input (to the propagating stage) for the second optical signal 455 and also acts as an output (from the propagating stage) for the first optical signal 453 (after it has been affected by the propagating stage). Thus, the interface portion 450 is further configured to receive an affected version of a respective first optical signal 453 from the second terminal 454 of each propagating stage and to receive an affected version of a respective second optical signal 455 from the first terminal 452 of each propagating stage. The interface portion is then configured to combine, via optical interference, each received affected version of each first optical signal 453 with each affected version of each second optical signal 455 to form a resultant optical signal. Furthermore, the combined signals may themselves be combined to form the resultant optical signal.

Referring again to FIG. 4B by way of example for one propagating stage, each propagating stage 325, 350 includes a set of components 457 arranged along and forming a single bidirectional optical pathway 456 between the first terminal 452 and the second terminal 454. The propagating stage is configured to propagate the first optical signal 453 along the optical pathway 456 in a first direction from the first terminal 452 to the second terminal 454 to be affected by the set of components 457 in a first manner to produce (at the second terminal 454) an affected version of the first optical signal 453. Similarly, the propagating stage is configured to propagate the second optical signal 455 along the optical pathway 456 in a second direction from the second terminal 454 to the first terminal 452 to be affected by the set of components 457 in a second manner different from the first manner to produce (at the first terminal 452) an affected version of the second optical signal 455.

FIGS. 4C, 4D and 4E illustrate different example embodiments of series, parallel, and series-parallel arrangements of multiple propagating stages. FIG. 4C illustrates multiple propagating stages coupled together in a series arrangement 470, also referred to as a cascaded arrangement. The interface portion 450 (e.g. multi-port optical coupler) is directly coupled to a first propagating stage 325. An optical coupler 472 is coupled to the first propagating stage 325 so that portions of optical signals propagating therein are fed to a second propagating stage 350b. Another optical coupler 472b is similarly coupled to the second propagating stage 350b so that portions of optical signals propagating therein are fed to a further propagating stage. This continues for n stages, where n is configurable by design. The last optical coupler 472n of the nth propagating stage 350n is shown. Optical signals split and merge at each optical coupler 472, 472b, . . . 472n so as to propagate through different propagating stages, where they can be differently affected by nonlinear components therein.

FIG. 4D illustrates multiple propagating stages coupled together in a parallel arrangement 480. The interface portion 450 (e.g. multi-port optical coupler) is directly coupled to multiple (e.g. three, as shown) propagating stages 325, 350a, 350b. Notably, the interface portion 450 is configured to operatively couple the feed portion to the parallel propagating stages 350a, 350b in substantially a same manner as the interface portion operatively couples the feed portion to the propagating stage 325. For example, pairs of ports of the multi-port optical coupler can be coupled to different respective end terminals of each propagating stage which forms a loop.

FIG. 4E illustrates multiple propagating stages coupled together in one form of series-parallel arrangement 490, also referred to as a hybrid arrangement. The interface portion 450 (e.g. multi-port optical coupler) is directly coupled to multiple (e.g. three, as shown) propagating stages 325, 350a, 350b. The propagating stage 350b is coupled in series to another propagating stage 350c. A multi-port coupler 492, for example coupled to the propagating stage 350c, is coupled in parallel to further propagating stages 350d, 350e. A further series of one or more propagating stages is coupled in series ending in propagating stage 350n. Other series-parallel arrangements are also possible.

In some embodiments, in a series, parallel or series-parallel arrangement, different respective outputs of at least two of the propagating stages can be received at different times due to different respective delays induced by such propagating stages. The different delays can be induced at least in part by having different lengths of spiral waveguides in different propagating stages, for example. In such embodiments, combining together different outputs of different propagating stages (to produce the resultant signal) can involve a temporal concatenation of the different respective outputs of the different propagating stages. For example, each propagating stage can have a different period of loop delay, and each output of each propagating stage can be collected at a different time corresponding to a time of the input signal plus its corresponding loop delay. The outputs of the different propagating stages could be provided one after the other by the interface component (e.g. optical coupler connected to the output stages). Thus, a form of temporal multiplexing can be performed. In some embodiments, this can allow for concurrent handling of different tasks by the apparatus as a reservoir computing apparatus.

FIG. 5A illustrates an apparatus 410 with a NALM configuration according to an embodiment, in which nonlinearity is obtained with a spiral waveguide 565 and an optical amplifier 570, as members of the set of components 457. Also illustrated is an optical input module 505 configured to generate an optical input signal 305, a figure-8 photonic apparatus 410 implementing a reservoir, and an optical output signal 340. Various details of this configuration are as described with respect to FIGS. 4A and 4B.

The optical input module 405 can, for example, include a source of continuous wave laser (CWL) 520 emitting a signal carrier to a first polarization controller (PC1) 525, and an arbitrary waveform generator (AWG) 530 used to encode the input signal. An electro-optic modulator 535, such as a Mach-Zehnder intensity modulator (IM) is also provided to modulate the signal carrier using the AWG. The resulting optical signal can be an optical input signal 305 directed to a first optical coupler 440 of the apparatus 410. Other types of optical input modules generating a modulated input optical signal (e.g. an intensity-modulated sample-and-hold optical signal) can also be used. It is noted that other types of modulators can be used, for example phase modulators or I/Q modulators.

In the first loop, the first optical coupler 440 combines the optical input signal 305 with a feedback optical signal from the attenuator 465 as already described above to produce the intermediate signal which is provided to the interface component 450, which can be a 2×2 optical coupler. The interface component provides first and second optical signals, generated at the interface component, to the second loop 555 (i.e. the propagating component), as already described above. The interface component provides a resultant optical signal toward the component 460, which generates the output signal 340 and also provides a portion toward the attenuator 465 for use in generating the feedback optical signal.

In the second loop 555, the CW propagating optical signal (first optical signal) encounters a second polarization controller (PC2) 560, a spiral waveguide 565, an amplifier 570 such as a semiconductor optical amplifier (SOA), and in some cases a filter 575. The spiral waveguide 565 can be made of nonlinear doped silica glass having a high-refractive index. The CCW propagating optical signal (second optical signal) encounters the same components 560, 565, 570, 575 in the opposite direction and in the opposite order.

FIG. 5B illustrates a particular implementation of the apparatus of FIG. 5A. The first optical coupler 440 is a 50:50 (e.g. 3 dB) optical coupler, and the interface component 450 is another 50:50 optical coupler. The interface component thus produces substantially equal CW and CCW propagating optical signals based on the received intermediate optical signal. The optical coupler 460 is a 10:90 optical coupler, such that 90% of the resultant optical signal is emitted as the optical output signal 340, and 10% of the resultant optical signal is propagated to a variable attenuator (VA) 465 and then back to the first 50:50 coupler 440. Other ratios in the optical coupler 460 may be used. The amplifier 570 is a semiconductor optical amplifier (SOA). The optical filter 575 is in place as a 200 GHz pass band filter and may be used to filter out amplifier noise.

The fixed parameters of a NALM configuration according to embodiments as illustrated in FIG. 5B can be as follows:
Cavity length L of the figure-8 photonic apparatus 410 implementing a reservoir: 14.4 m
Cross-section of spiral waveguide 465: 1.45×1.5 μm²
Device latency: ˜77 ns
Nonlinear parameter: γ=220W⁻¹ km⁻¹

The tunable parameters of a NALM configuration according to embodiments can include:
Nonlinear gain tuning of the apparatus (e.g. reservoir computing apparatus) 410 controlled via the SOA 470.
Fading memory tuning of the apparatus 410 controlled via the VA 465.

The use of a figure-8 configuration can allow operation of a device in different operational regimes. The choice of a regime can be controlled with various degrees of freedoms (i.e. tunable hyperparameters) such as the coupling ratio of each coupler, signal polarization, and gain control of a feedback loop. A strong nonlinearity, as well as access to different operational regimes, can make an embodiment more versatile and efficient than alternatives. Gain control of a feedback loop can allow tuning according to the complexity and degree of non-separability required by a specific ML task.

In more detail, the RC approach, due to the possibility of adjusting the number of virtual nodes (hence the dimension of the space where one can represent independent coordinates, called also system phase space), allows linearly non-separable problems (e.g., classification tasks) in a low dimensional space to become linearly separable in a higher dimensional space. In other words, given a complex problem (linearly non-separable) and desiring to use simple training algorithms (e.g., linear methods for training, like linear regression), one can increase the number of reservoir nodes, thus the dimension of the system so that the one can use linear methods for training.

FIG. 5C is a graph showing a nonlinear activation function as can be implemented by an embodiment. By tuning a system parameter via SOA current over an operational region 590, a signal parameter can be adjusted nonlinearly and optimized. The operational range 590 can additionally or alternatively be adjusted by varying other system parameters. By changing the operational range 590, the nonlinearity characteristic (input-output curve) of the activation function can be altered (controllably varied). This alteration can facilitate adapting the apparatus to different machine learning (e.g. reservoir computing) tasks. This operational range can be changed for example by varying the amount of attenuation of a variable attenuator of the feed portion of the apparatus.

Capabilities of a device according to embodiments can be demonstrated using a benchmark task such as the forecasting of a chaotic time series, which can be a test bed for RC and ML predictive models, for example in association with RNNs. The forecasting of a chaotic time series can be used to predict a change over time, of data that is relevant to problems such as network traffic monitoring and failure prediction, financial values and transactions, and scientific applications.

One such chaotic time series is referred to as a Mackey-Glass (MG) time-series. It is governed by the following nonlinear time-delay differential equation, in which signal amplitude values x(t) are difficult to predict if time t is large:

$$\frac{dx ( t )}{dt} = β \frac{x ( t - τ )}{1 + {x ( t - τ )}^{n}} - γ x ( t )$$

and where τ is a time delay, and β, γ and n are parameters.

Another nonlinear time-delay differential equation whose long-term values are hard to predict is known as the 10^{th} order nonlinear autoregressive moving average (NARMA10):

$$\frac{dx}{dt} = α {x}_{t - 1} + β {x}_{t - 1} {\sum }_{i}^{n} {x}_{t - i} + γ {y}_{t - n} {u}_{t - 1} + δ$$

$$β , γ , n > 0$$

Depending on the values of parameters α, β, γ, δ, and n, this equation shows a range of periodic and chaotic dynamics, making long term predictions very difficult, and a good test bed to verify the accuracy of RCs and ML predictive models.

In a testing context, the goal is to train a device according to an embodiment to reconstruct an initial waveform and, ultimately, to be able to predict future values of a time series. However, the apparatus as described herein can be used for other diverse tasks, such as the reconstruction of distorted telecommunications signals.

To test an embodiment as a proof of concept, a NALM configuration can be implemented with a propagating stage 325 having a single loop, for example as illustrated in FIG. 4C and described above. Information or data can be encoded via intensity modulation of a narrowband source of continuous wavelength laser (CWL) 420. Specifically, the data can be encoded in an optical input signal 305 using a “sample and hold” procedure, by which data points are injected sequentially over a time T covering many round trips in the loop of a propagating stage 325, each one taking time T′ (T′≤T). A time-varying optical input signal 305 encoding data can be produced by a generator of arbitrary waveforms, or by a field-programmable gate array (FPGA) driving an electro-optic modulator. Before entering the propagating stage 325 having a single loop, an optical input signal 305 can be masked with a single- or a multi-level random mask.

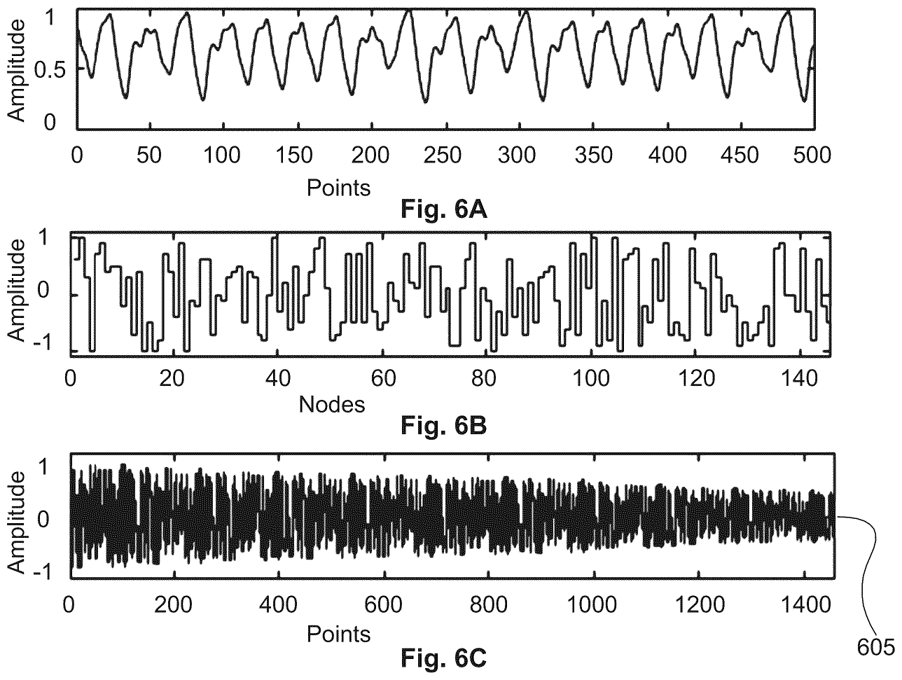

FIG. 6A is a graph sampling the Mackey-Glass time-series, as can be used to test the performance of a device according to an embodiment. Mackey-Glass data can be masked and the masked result can be encoded as an optical input signal to a device with a NALM configuration with a single propagating stage (single loop).

FIG. 6B is graph representing a 20-level random mask that can be applied to the Mackey-Glass time series of FIG. 6b, before it is encoded and provided as an optical input signal to a device according to an embodiment. The mask is used to map the input data into a higher-dimensional phase space.

FIG. 6C is a graph of the Mackey-Glass time-series of FIG. 6A, after being processed by the mask of FIG. 6B, and as it can be encoded as an optical input signal to test a device according to an embodiment. For a prediction task, a total of 1400 data points from an MG time series can be generated and masked 605.

The operations of generating data with a Mackey-Glass time series and masking it can generate a number N of nodes (virtual points) for an RC reservoir of a RNN, for which a temporal separation θ=T′/N between virtual points can be defined. The temporal separation θ can represent a desynchronization between the period τ of an optical input signal 305, and the cavity round trip time T′.

A desynchronization θ can be necessary to achieve a complex transient dynamic, and to ensure that the state of each virtual point 210 is dependent on the states of neighboring virtual nodes points 210, thereby realizing the interconnections defining the reservoir network 205.

In a NALM configuration, parameters of a propagating stage 325 of a device having a single loop can be as follows:
Length: L=14.4 m;
Round-trip time: T=81.5 ns;
Latency: λ=1/T′˜12.3 MHz;
Number of virtual points: N=162;
Bit rate˜12.3 Mbits/s (consequential to 1 bit injected per round-trip time);
Desynchronization parameter: k=1;
Temporal separation: θ=0.5 ns (consequential to k=1), with the
Total temporal length of the input time-scale: T′=81 ns (T′=Nθ=162×0.5 ns)

In order to record the dynamics of the node states, a fraction (10%) of the circulating optical power can be coupled out from the device with a 10:90 coupler as in FIG. 4C.

For a benchmark prediction task, an information encoding signal 605 can be split into a training data set of 900 data points, and a testing data set of 300 data points. For training, a linear regression algorithm can be used to calculate the set of weight values Wᵢ that minimize the NMSE values, i.e., the set of weight values Wᵢ that minimize the mismatch between an optical output signal 340 from the device after processing, and a targeted output signal. Other techniques such as regularization techniques (e.g., ridge regression) or more sophisticated approaches (e.g., gradient descent) can also be used. Once training has been performed, the weight values Wᵢ can be used to predict any remaining testing data.

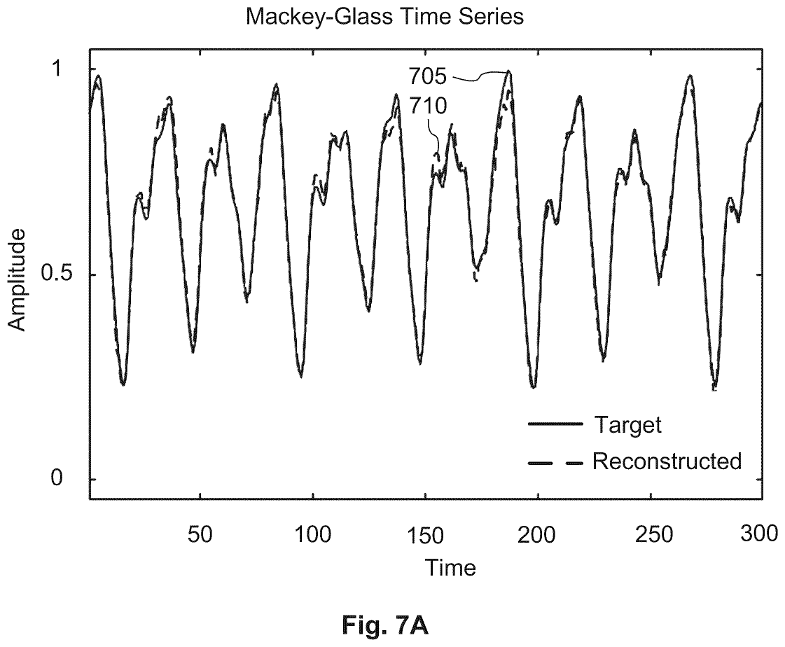

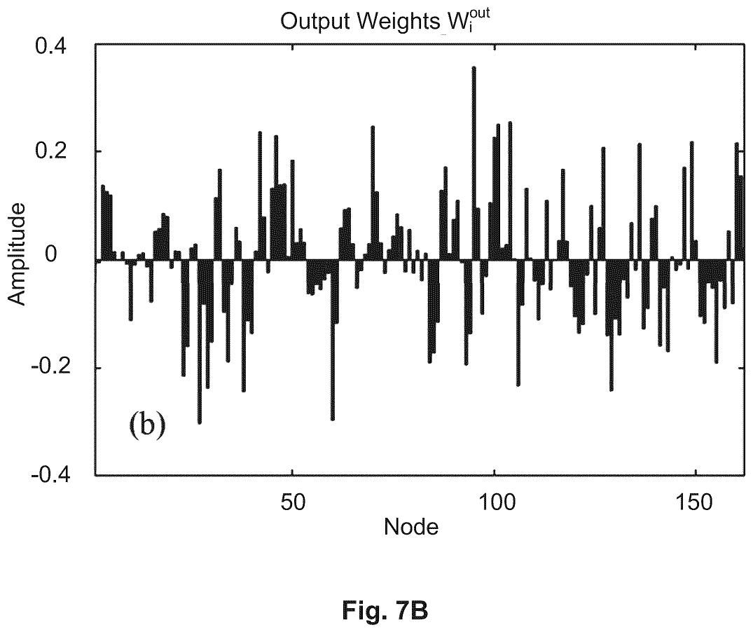

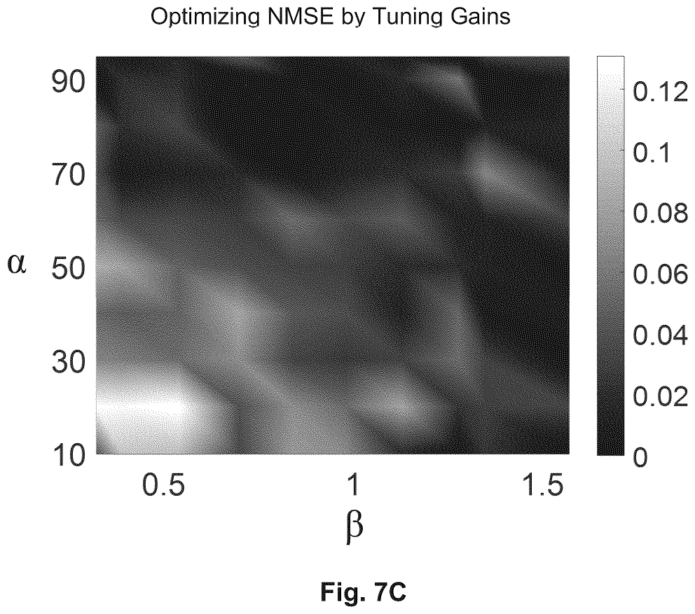

FIG. 7A is a graph showing the results of a Mackey-Glass time series prediction, according to an embodiment. The solid line 705 shows a target waveform, while the dashed line 710 represents a waveform as reconstructed by a device having a NALM configuration with a propagating stage 325 of a device having a single loop (i.e. single propagating stage).

Training weights for each virtual point of a phase space can be implemented digitally in post-processing, but they can also be implemented by optical means, such as with programmable filters or modulators.

FIG. 7B is a graph showing the weight by each virtual point of a phase space, as determined by a ridge regression, of a device according to an embodiment.

In the case of a NALM configuration, a gain control component 345 (or 465) can allow independent to adjust additional nonlinearity contributions (via the control parameter α). By using an additional (e.g. gain) component, the attenuation or gain of the optical input signal can also be controlled. FIG. 7C illustrates NMSE values for various value combinations of the two parameters α and β. By tuning α and β, as well as the average input power, it is possible to obtain NMSE values as low as 1%, and to optimize a device for a given ML task. Optimized operational regimes can be found via parametric sweeps, evolutionary algorithms, other techniques, or a combination thereof.

By using different wavelength channels, embodiments can be used to process data with a high degree of parallelism, and therefore with increased processing data rates. In such cases, data can be encoded to a plurality (a number N_{c}) of different wavelengths channels of an optical input signal simultaneously, by using electro-optic modulators. For example, an optical input signal can include multiple sub-signals, each limited to a different respective wavelength band. The apparatus can then be configured to process the multiple sub-signals in parallel via wavelength division multiplexing. Photonic devices such as this can exhibit a relatively wide bandwidth allowing such wavelength (or frequency) division multiplexing to be readily performed.

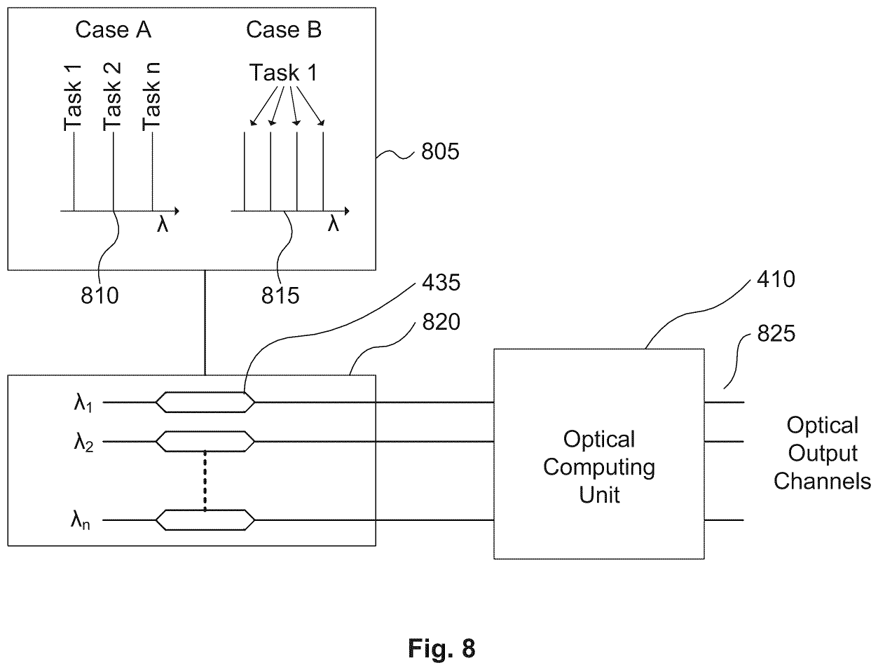

FIG. 8 illustrates a scheme for optically processing data in parallel, according to an embodiment. Such an embodiment can be used in one of two ways. One way is for a set of data 805 to be split into different tasks that are to be encoded onto respective optical wavelength channels that can be processed in parallel. This can be referred to as Case A 810. In a Case B 815, the data of a single task can be split into different wavelength channels. Once the data is split as desired, it can be encoded onto the different wavelengths of an encoder 820 consisting of respective electro-optic modulators 435. Accordingly, embodiments of the present disclosure can parallelize data processing via wavelength division multiplexing.

From there, optical input signals can be sent to a photonic apparatus 410 implementing an optical reservoir computing unit according to an embodiment. Optical signals of different wavelength can be generated with multiple CWLs 420, optical frequency combs, filtering a broadband optical source, or a combination thereof.

In an embodiment, time delays for the optical signals as well as for electrical signals modulating electro-optic modulators 435 can be appropriately selected. It is also possible for the number of electro-optic modulators 435 to be smaller.

In Case A 810, separate tasks can be encoded onto different optical wavelengths and sent into a photonic apparatus 410 implementing an optical reservoir computing unit according to an embodiment. Each channel can then be individually read, using optical filters and photodetectors can be used for training.

To experimentally test Case A 810, two different benchmarking tasks can be used together. One benchmarking task is an MG time series prediction task encoded to a 1549.2 nm channel, and the other is a NARMA10 (Nonlinear Autoregressive Moving Average of 10th order) time series prediction task, encoded to a 1549.4 nm channel. The spacing between both channels can be as narrow as 20 GHz.

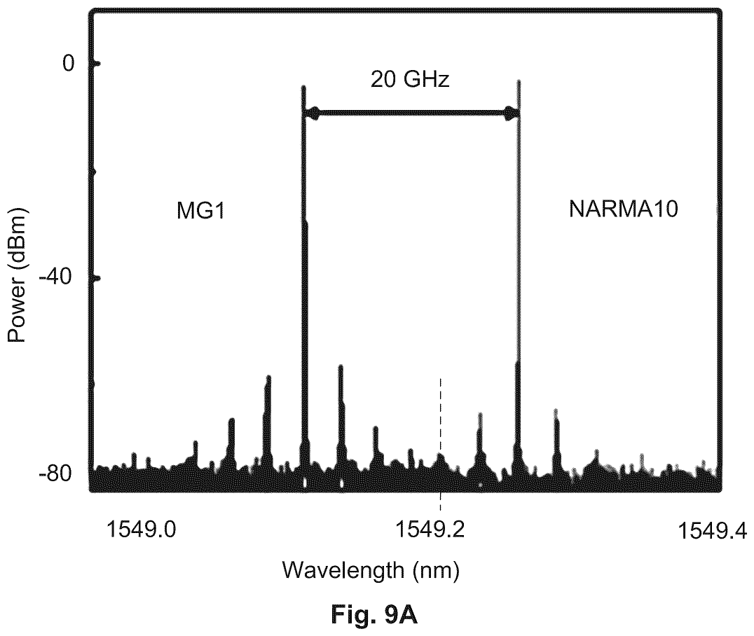

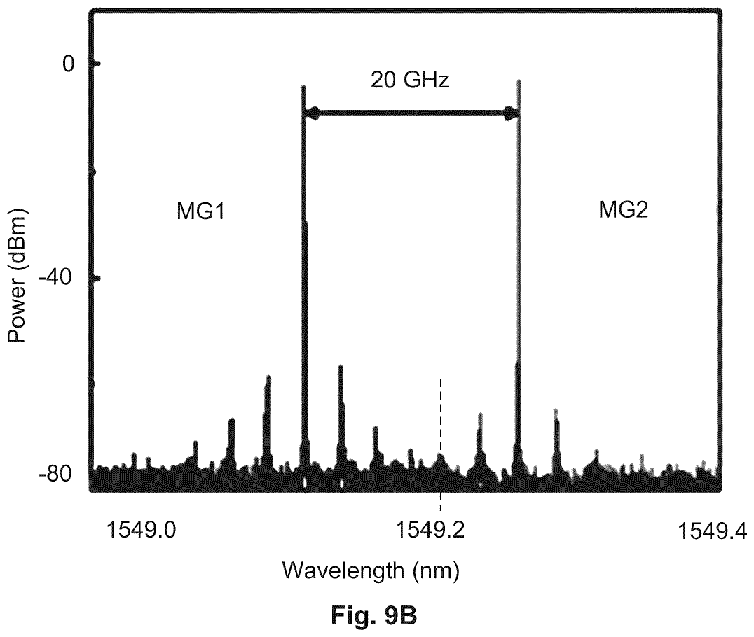

FIG. 9A is a spectrum of optical wavelengths encoding data representing two independent tasks, in order to demonstrate parallel processing of two independent tasks according to an embodiment. Optical wavelengths below 1549.2 nm encode data from an MG time series, and optical wavelengths between 1549.2 nm and 1549.4 nm encode data from a NARMA10 time series. Each time series represents a different task and it is encoded to a different channel, as required to test Case A 810.

In Case B 815, a single task is split into different wavelength channels and be computed with a high degree of parallelism. This can significantly increase a bit rate, and mitigate the latency of a device. To demonstrate the capability of a device according to Case B 815, a sequence data points from an MG time series can be divided in two individual wavelength channels (FIG. 9B). Both channels can then be processed simultaneously in the device.

FIG. 9B is a spectrum of optical wavelengths encoding data from a single task, but split in two data channels, in order to demonstrate parallel processing of two data channels of a same task, according to an embodiment. Optical wavelengths below 1549.2 nm encode data from an MG time series, and optical wavelengths between 1549.2 nm and 1549.4 nm encode data from the same MG time series. Each part of the MG time series represents a different part of the same task and it is encoded to a different channel, as required to test Case B 815.

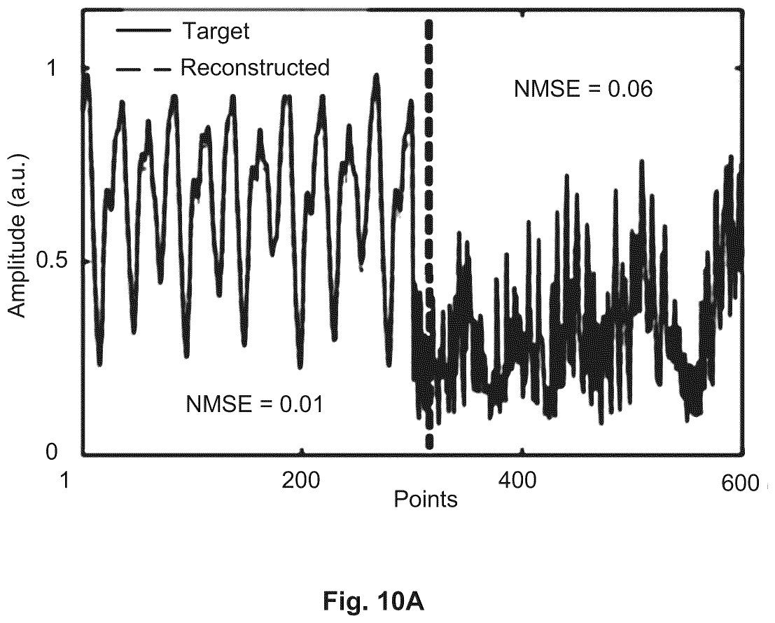

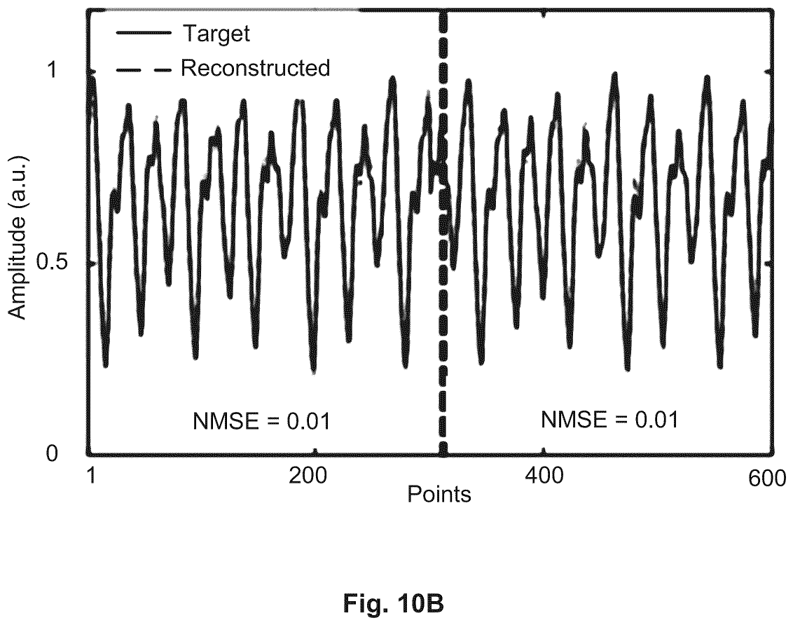

To test Case A 810, offline training can be separately done on the two output channels separately, by using an ML supervised technique applied for the case of a single input. Results of training in terms of NMSE (FIG. 10A) show an error of 1% for the MG series and an error of 6% for the NARMA10 series, both of which are excellent accuracy for signal prediction.

In more detail, FIG. 10A is a graph showing the results from an offline training operation on the two data sets of FIG. 9A, according to an embodiment. The resulting prediction error on channel MG1 is NMSE_{MG-1}=1%, and for the NARMA10 channel, it is NMSE_{N10}=6%.

FIG. 10B is a graph showing the results from an offline training operation on the two data sets in FIG. 9B, according to an embodiment. The resulting prediction error on channel MG1 is NMSE_{MG1}=1%, and for channel MG2, it is NMSE_{MG2}=1%.

Another testbed to demonstrate the suitability and capability of an embodiment for parallel information processing, parallel processing information 9 channels (N_{c}=9) (FIG. 8) can be verified by performing a telecommunications PAM4 signal recovery task (“PAM4” referring to pulse-amplitude modulation with four levels of pulse modulation).

In a PAM4 signal recovery task, a sequence of more than 1200 bits of information can be encoded and distributed onto 9 frequency channels within the operational bandwidth of a device according to embodiments. In some embodiments, for training, either 900 bits or 300 bits can be used for the prediction. A linear regression algorithm can be used for a training operation.

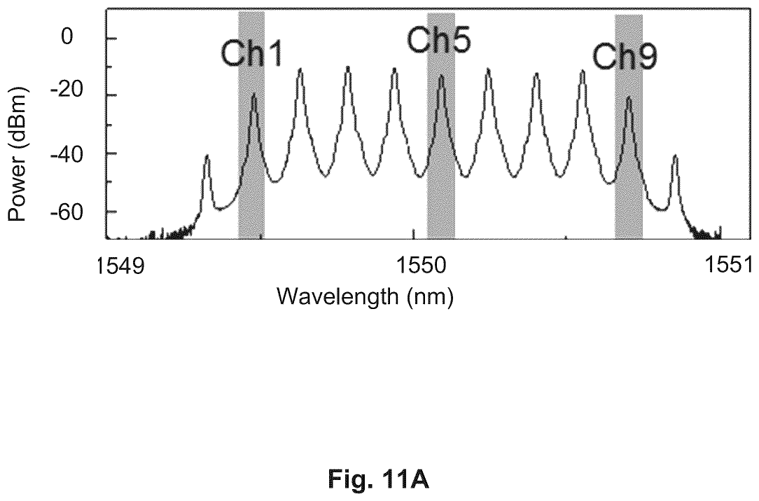

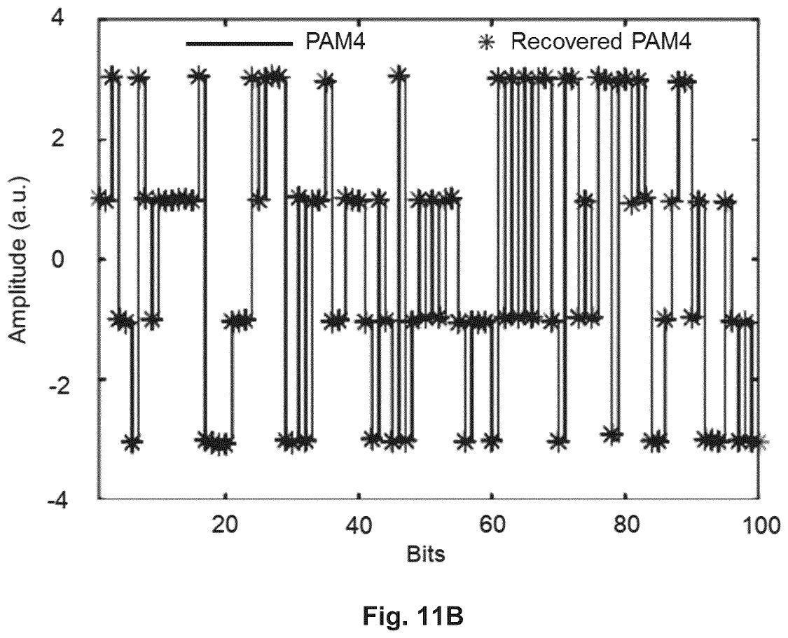

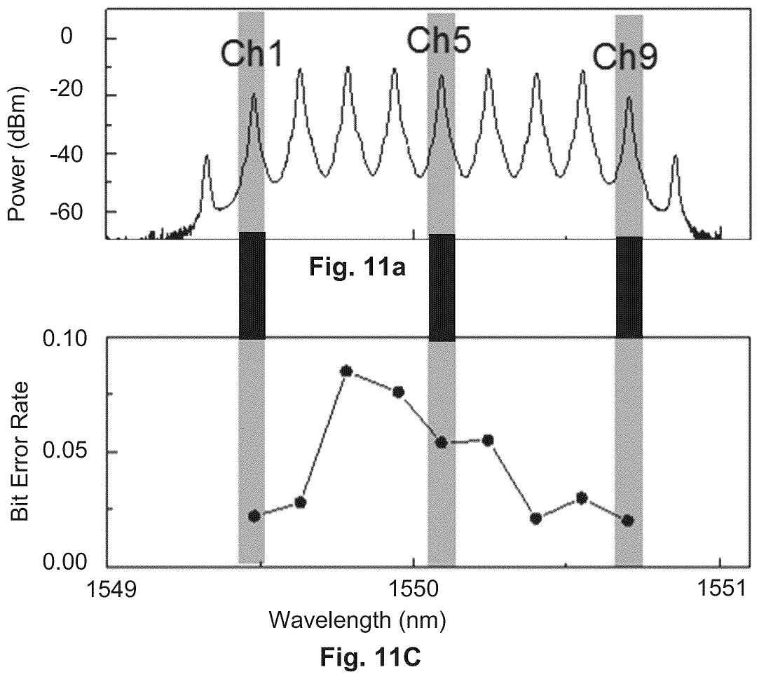

FIG. 11A is a spectrum including 9 frequency channels onto which 1200 bits of information are encoded, in order to perform a PAM4 signal recovery task to test an embodiment.

After an offline training operation, a PAM4 recovery task can produce, from the data sequence on the 9 frequency channels, a recovered PAM4 signal.

FIG. 11B shows a recovered PAM4 signal over the first 100 bits, after an offline training operation, according to an embodiment.

FIG. 11C shows the BER of the recovered PAM4 signal after offline training, shown in FIG. 8b, according to an embodiment. The BER is less than 10% and the variation in BER in each channel is due to cross-talk arising from the broad spectral filtering. For comparison, FIG. 11A is duplicated.

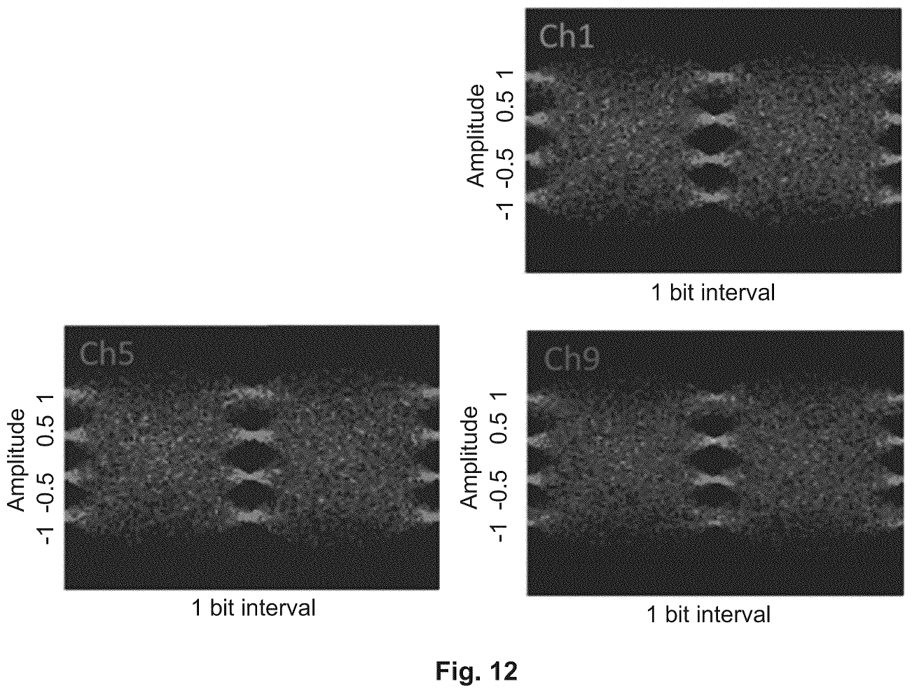

FIG. 12 shows reconstructed eye diagrams obtained for 3 channels of FIG. 11A of the 9 channels. For all three of Channel 1, Channel 5 and Channel 9, a well-defined three-eye opening can be seen. This is a signature of high accuracy in retrieving the initial bit sequence with a device according to an embodiment. The maximum bit rate is approximately 112 Mbit/s.

Embodiments include different configurations for an optical apparatus implementing a reservoir for an RNN architecture, allowing the system as a whole to address drawbacks of the prior art.

A time-multiplexing approach in the optical domain can be used to demonstrate that a device according to embodiments has parallelization capabilities that are suitable for ML multitasking. Capabilities include simultaneous encoding of data onto multiple frequency channels, different polarization states, or combinations thereof. This can allow a high bit rate (i.e. a high channel capacity) and a potential decrease in latency by an order of magnitude, i.e. down to less than a nanosecond.

Compared to other RNN architectures, a device according to embodiments can potentially address performance demands of smart applications for IoT in terms of speed, bandwidth, and energy efficiency. As such, the range of processing speeds (the inverse of latency) of an embodiment can be between hundreds of MHz, up to tens of GHz, depending on the number of frequency channels encoded.

Furthermore, by using integrated photonic components, embodiments can potentially allow the realization of a fully on-chip programmable integrated photonic RNN, usable for many applications. Such devices can be used for next-generation telecommunications systems where fast processing of vast data amounts with low power consumption is desired.

Embodiments include different configurations and frameworks to process information optically in the domain of RNNs, including partially and fully connected RNNs, single-layer RNNs, multi-layer RNNs, and deep RNNs. Configurations may be based on a figure-8 interferometer implementing a feedback loop. Possible variations include the components realizing a propagating stage 325, and the nonlinear activation function implemented by the propagating stage 325.

Embodiments include methods to densely encode information for parallel optical processing, based on wavelength division multiplexing in the time domain, using multiple frequency channels, different polarization states, or combinations thereof. This can increase bit rate (channel capacity) and latency limitations, and allow more advanced ML multitasking.

Embodiments include methods to adjust the memory (e.g. associated with RC delayed feedback) and performance of a device, by controlling the gain control. This can allow compatibility with certain complex ML tasks. Moreover, this may include single-channel or multi-channel operation, the latter of which can allow parallel processing or multitasking. Embodiments also include switching between serial and parallel loops, and the implementation of different nonlinear activation functions, and switching from one nonlinear activation function to another.

Embodiments include an architecture that is coherent in terms of optical signal propagation, and that potentially requires little energy for operation and stabilization. Stabilization can be improved through the use of stabilization components such as filters, polarization controllers, and if necessary, active stabilization schemes.

Embodiments can be used to perform telecommunications tasks, including optical header recognition, optical signal regeneration, as well as other complex classification tasks that are of particular interest for next-generation smart IoT applications, where fast processing of vast data amounts can be required.

Embodiments can also be potentially used in a variety of domains other than telecommunications, including big data processing, image recognition, computer vision applications, global search engines, smart traffic grids, data encryption, voice, language or speech recognition, medical diagnostics, gene and microbiome sequencing, laser architectures, metrology, quantum applications and others. Additionally, future artificial intelligence (AI) technologies based on photonics can benefit from embodiments in order to reduce their energy consumption and mitigate impacts on climate change from current smart technology.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A photonic apparatus comprising:
a propagating stage comprising a set of components arranged along and forming a single bidirectional optical pathway between a first terminal and a second terminal, the propagating stage configured to propagate a first optical signal along the optical pathway in a first direction from the first terminal to the second terminal to be controllably affected by the set of components in a first manner to produce an affected version of the first optical signal, and to propagate a second optical signal along the optical pathway in a second direction from the second terminal to the first terminal to be controllably affected by the set of components in a second manner different from the first manner to produce an affected version of the second optical signal, wherein the set of components of the propagating stage is configured to produce a nonlinear relationship between the intermediate optical signal and the resultant optical signal, said nonlinear relationship providing a nonlinear activation function of the photonic apparatus operating to implement one or more reservoir computing nodes of a recurrent neural network.

2. The photonic apparatus of claim 1, further comprising:
an input terminal configured to receive an optical input signal; and
an interface portion configured to:
receive an intermediate optical signal which comprises the optical input signal;
provide, to the first terminal of the propagating stage, the first optical signal as a first portion of the intermediate optical signal;
provide, to the second terminal of the propagating stage, the second optical signal as a second portion of the intermediate optical signal;
receive the affected version of the first optical signal from the second terminal of the propagating stage;
receive the affected version of the second optical signal from the first terminal of the propagating stage; and
combine, via optical interference, the affected version of the first optical signal with the affected version of the second optical signal to form a resultant optical signal.

3. The photonic apparatus of claim 2, further comprising:
a feed portion configured to:
receive the optical input signal from the input terminal;
receive a portion of the resultant optical signal;
using a controllably variable amount of attenuation, produce an attenuated version of said portion of the resultant optical signal; and
combine the optical input signal with the attenuated version of said portion of the resultant optical signal to generate the intermediate optical signal; and
an output terminal configured to provide another portion of the resultant optical signal.

4. The photonic apparatus of claim 1, wherein the amount of attenuation is controllably variable to implement a controlled variation of the nonlinear activation function, and wherein the controlled variation comprises a controlled variation in nonlinearity characteristics of the nonlinear activation function.

5. The photonic apparatus of claim 1, wherein the set of components of the propagating stage includes a spiral waveguide operating as a nonlinear component contributing to providing said nonlinear activation function, wherein the spiral waveguide is a nonlinear waveguide.

6. The photonic apparatus of claim 1, wherein the set of components of the propagating stage further comprises a controllable gain element, and wherein the controllable gain element cooperates with additional members of the set of components to provide said nonlinear activation function as a controllable nonlinear activation function.

7. The photonic apparatus of claim 1, wherein the feed portion establishes a first optical signal loop, the propagating stage establishes one or more second optical signal loops coupled to the first optical signal loop, and the first optical signal loop and the one or more second optical signal loops are cooperatively configured to provide a delayed feedback facilitating implementation of said reservoir computing nodes.

8. The photonic apparatus of claim 1, wherein the propagating stage and the interface portion together form a nonlinear amplifying loop mirror or a nonlinear optical loop mirror.

9. The photonic apparatus of claim 1, wherein the interface portion is an optical coupler having at least two inputs and at least two outputs.

10. The photonic apparatus of claim 1, further comprising a plurality of propagating stages including the propagating stage, each of the plurality of propagating stages having a same structure and configuration as the propagating stage.

11. The photonic apparatus of claim 10, wherein the interface portion is configured to operatively couple the feed portion to at least two of the plurality of propagating stages in a same manner as the interface portion operatively couples the feed portion to the propagating stage to implement a parallel arrangement.

12. The photonic apparatus of claim 11, wherein the interface portion is configured to combine outputs of each of said at least two of the plurality of propagating stages together to produce the resultant signal.

13. The photonic apparatus of claim 12 wherein different respective outputs of said at least two of the plurality of propagating stages are received at different times due to different respective delays of said at least two of the plurality of propagating stages, and wherein said combining outputs comprises a temporal concatenation of the different respective outputs of said at least two of the plurality of propagating stages.

14. The photonic apparatus of claim 12, wherein said combining outputs comprises a wavelength division multiplexing of the different respective outputs.

15. The photonic apparatus of claim 10, wherein the plurality of propagating stages includes a second propagating stage operatively coupled to the propagating stage in a series arrangement.

16. The photonic apparatus of claim 10, wherein the plurality of propagating stages are configured in a series arrangement, a parallel arrangement, or a series-parallel arrangement.

17. The photonic apparatus of claim 1, wherein the optical input signal comprises multiple sub-signals each limited to a different respective wavelength band, the apparatus configured to process the multiple sub-signals in parallel via wavelength division multiplexing.

18. The photonic apparatus of claim 1, wherein said set of components of the propagating stage includes a controllable bi-directional amplifier.

19. The photonic apparatus of claim 1, wherein said set of components of the propagating stage includes one or more of: a spiral waveguide with nonlinear optical characteristics; a waveguide with nonlinear characteristics; a microring resonator with nonlinear characteristics; a photonic crystal optical fiber or waveguide with nonlinear characteristics; and an optical fiber with nonlinear characteristics.

20. A method comprising:
receiving, at an input terminal of a photonic apparatus, an optical input signal;
at a propagating stage of the photonic apparatus, the propagating stage comprising a set of components arranged along and forming a single bidirectional optical pathway between a first terminal and a second terminal: propagating a first optical signal along the optical pathway in a first direction from the first terminal to the second terminal to be controllably affected by the set of components in a first manner to produce an affected version of the first optical signal; and propagating a second optical signal along the optical pathway in a second direction from the second terminal to the first terminal to be controllably affected by the set of components in a second manner different from the first manner to produce an affected version of the second optical signal, wherein the set of components of the propagating stage produce a nonlinear relationship between the intermediate optical signal and the resultant optical signal, said nonlinear relationship providing a nonlinear activation function of the photonic apparatus operating to implement one or more reservoir computing nodes of a recurrent neural network;
at an interface portion of the photonic apparatus:
receiving an intermediate optical signal which comprises the optical input signal;
providing, to the first terminal of the propagating stage, the first optical signal as a first portion of the intermediate optical signal;
providing, to the second terminal of the propagating stage, the second optical signal as a second portion of the intermediate optical signal;
receiving the affected version of the first optical signal from the second terminal of the propagating stage;
receiving the affected version of the second optical signal from the first terminal of the propagating stage; and
combining, via optical interference, the affected version of the first optical signal with the affected version of the second optical signal to form a resultant optical signal;
at a feed portion of the photonic apparatus:
receiving the optical input signal from the input;
receiving a portion of the resultant optical signal;
using a controllably variable amount of attenuation, producing an attenuated version of said portion of the resultant optical signal; and
combining the optical input signal with the attenuated version of said portion of the resultant optical signal to generate the intermediate optical signal; and
at an output terminal of the photonic apparatus, providing another portion of the resultant optical signal.
